(19) United States
(12) Patent Application Publication
(10) Pub. No.: US 2011/0014519 A1
(43) Pub. Date: Jan. 20, 2011

(54) METHOD FOR FORMING DEPOSITED FILM

(76) Inventors: Sadayuki Okazaki, Osaka (JP); Kazuyoshi Honda, Osaka (JP)

Correspondence Address: MCDERMOTT WILL & EMERY LLP, 600 13TH STREET, NW, WASHINGTON, DC, 20005-3096, US

(21) Appl. No.: 12/866,652

(22) PCT Filed: Feb. 6, 2009
(86) PCT No.: PCT/JP2009/000467

§ 371 Date: Aug. 6, 2010

(30) Foreign Application Priority Data
Feb. 8, 2008 (JP) 2008-028452

(51) Int. Cl. H01M 4/02; H01M 4/04

(52) U.S. Cl. 429/209; 427/58

(57) ABSTRACT

The present invention provides a vacuum deposition apparatus configured to simultaneously form a power collecting lead forming portion and an electrode active material portion of a lithium-ion secondary battery and having excellent mass productivity. With shutters 12a and 12b closed, a substrate 4 winding around a first roll 3 is unroll to be conveyed to a second roll 8, and the substrate 4 stops when it reaches first and second deposition possible regions 60a and 60b. Here, the shutter 12a opens, and a deposition material in a crucible of an evaporation source 9 is evaporated to be supplied to a surface of the substrate 4 which is located in the first deposition possible region 60a. With this, a first layer is formed as a deposited film on the surface of the substrate 4. After the deposition is carried out with respect to the substrate 4 for a predetermined period of time, the shutter 12a is closed. Next, the substrate 4 is again conveyed and stops when the portion on which the deposition has been carried out in the first deposition possible region 60a has reached the second deposition possible region 60b. The shutters 12a and 12b open, and the deposition is carried out again. Thus, the first layer is formed in the first deposition possible region 60a, and the second layer having a different growth direction from the first layer is formed as the deposited film on the first layer in the second deposition possible region 60b.

### TECHNICAL FIELD

The present invention relates to a method for forming a deposited film.

### BACKGROUND ART

As mobile devices increase in performance and functionality in recent years, secondary batteries used as power supplies of these mobile devices need to be increased in capacity. As the secondary battery which can satisfy such need, a nonaqueous electrolyte secondary battery is attracting attention. In order to increase the capacity of the nonaqueous electrolyte secondary battery, proposed is to use silicon (Si), germanium (Ge), tin (Sn), or the like as an electrode active material (hereinafter simply referred to as “active material”). A nonaqueous electrolyte secondary battery electrode (hereinafter simply referred to as “electrode”) using such electrode active material is generally formed by applying a slurry containing the electrode active material, a binder, and the like to a current collector (such electrode is hereinafter referred to as “coat-type electrode”). However, since the active material vigorously expands and shrinks by the repetition of charge and discharge, it may be crushed or miniaturized. In a case where the active material is crushed or miniaturized, a problem is that a power collecting property of the electrode deteriorates. Moreover, since a contact area between the active material and an electrolytic solution increases, a decomposition reaction of the electrolytic solution by the active material is accelerated, and this causes another problem that an adequate charge-discharge cycle characteristic cannot be obtained. Further, since the coat-type electrode contains an electrically conductive material, a binder, and the like, it is difficult to increase the capacity of the electrode.

Here, instead of the coat-type electrode, manufacturing an electrode by forming an active material layer on the current collector using a vacuum process, such as deposition, sputtering, or CVD has been studied. As compared to the coat-type electrode, the electrode manufactured by the vacuum process can suppress the miniaturization of the active material layer and increase the adhesion between the current collector and the active material layer. Therefore, an electron conductivity of the electrode can be improved, and the capacity and charge-discharge cycle characteristic of the electrode can be improved. In addition, since the electrically conductive material and the binder contained in the electrode can be reduced or removed, the capacity of the electrode can be essentially increased.

However, even if the vacuum process is used, the current collector and the active material layer may be separated from each other by the expansion and shrinkage of the active material during charge and discharge, and the current collector may wrinkle by stress applied thereto. This causes the deterioration of the charge-discharge cycle characteristic.

Here, Patent Documents 1 and 2 filed by the present applicants have proposed that an active material body layer is formed by depositing silicon particles on the current collector from a direction inclined with respect to a normal direction of the current collector (oblique deposition). Such active material body layer is formed by utilizing a below-described shadowing effect and is structured such that columnar active material bodies inclined in one direction with respect to the normal direction of the surface of the current collector are arranged on the surface of the current collector. In accordance with this structure, a space for buffering an expansion stress of the silicon can be secured between the active material bodies. Therefore, the active material body can be prevented from separating from the current collector, and the current collector can be prevented from wrinkling. Thus, the charge-discharge cycle characteristic can be improved than before.

Moreover, in order to more effectively buffer the expansion stress of the active material applied to the current collector, Patent Document 2 proposes the formation of the active material bodies grown in a zigzag manner by carrying out the oblique deposition for plural stages while changing the deposition direction. For example, such zigzag active material body is formed as below.

First, a first portion is formed on the current collector by carrying out the deposition from a first direction inclined with respect to the normal direction of the current collector (deposition step for the first stage). Then, a second portion is formed on the first portion by carrying out the deposition from a second direction which is inclined with respect to the normal direction of the current collector and is inclined on an opposite side of the first direction (deposition step for the second stage). Further, a third portion is formed by carrying out the deposition from the first direction (deposition step for the third stage). The deposition step is repeated while changing the deposition direction until an arbitrary number of layers are formed. Thus, the active material body is obtained.

The formation of such active material body can be carried out using a deposition apparatus described in Patent Document 2, for example. In the deposition apparatus described in Patent Document 2, a fixing base for fixing the current collector is provided above an evaporation source. The fixing base is provided such that the surface thereof is inclined with respect to a plane parallel to an evaporation surface (upper surface of the deposition material) of the evaporation source. With this, the deposition material can be incident on the surface of the current collector from a direction inclined by an arbitrary angle with respect to the normal direction of the current collector. Moreover, an incident direction (deposition direction) of the deposition material can be changed by changing an inclination direction of the fixing base. Therefore, the above-described zigzag active material body can be obtained by repeating the deposition step for plural stages while changing the inclination direction of the fixing base. Patent Document 2 further describes that instead of changing the inclination direction of the fixing base, the incident direction of the deposition material is changed by moving the evaporation source or by alternately using a plurality of evaporation sources.

Patent Documents 3 to 5 disclose a roll-to-roll type deposition apparatus suitably used in a mass production process.

Patent Document 3 proposes that the active material layer is formed by the oblique deposition using the roll-to-roll type deposition apparatus. In the deposition apparatus, a sheet-shaped current collector travels from a winder to an unwinder in a chamber, and a deposited film (active material layer) can be continuously formed on the surface of the traveling current collector in a predetermined deposition region. In this deposition region, the deposition material is incident on the surface of the current collector from one direction inclined with respect to the normal direction of the current collector. Therefore, it is possible to form a columnar active material body inclined in a specific direction with respect to the normal direction of the current collector.

Patent Document 4 discloses roll-to-roll type deposition apparatuses of various configurations as the deposition apparatus configured to continuously produce an electrode material for electrolytic condensers. For example, proposed is a configuration in which two deposition rolls are provided for one evaporation source and metal particles evaporated by the evaporation source are deposited on the surface of the substrate on each deposition roll, so that two deposition regions are formed for one evaporation source.

Patent Document 5 proposes a method (FIG. 6) in which when forming the active material layer by the oblique deposition using the roll-to-roll type deposition apparatus, the current collector is held in a V shape, and the active material layer is formed such that the deposition material is incident from two directions while causing the current collector to travel.

Further, Patent Document 6 proposes that in order to solve problems which occur when the active material layer is deposited on the surface of the current collector while causing an elongated current collector to travel, the active material layer is deposited with the elongated current collector kept still. Patent Document 6 describes that in this case, the active material layer may be continuously formed, or the active material layers may be intermittently formed while leaving a non-forming region therebetween.

Patent Document 1: Pamphlet of International Publication No. 2007/015419

Patent Document 2: Pamphlet of International Publication No. 2007/052803

Patent Document 3: Japanese Laid-Open Patent Application Publication No. 2007-128659

Patent Document 4: Japanese Patent No. 2704023

Patent Document 5: Japanese Laid-Open Patent Application Publication No. 10-130815

Patent Document 6: Japanese Laid-Open Patent Application Publication No. 2007-317419

### DISCLOSURE OF THE INVENTION

### Problems to be Solved by the Invention

Since the deposition apparatus described in each of Patent Document 1 and Patent Document 2 carries out the deposition with respect to the current collector which is precut to have a predetermined size, the productivity is low. Therefore, it is difficult to apply this deposition apparatus to the mass production process.

Moreover, it is difficult to continuously form the active material body grown in the zigzag manner described in Patent Document 2 by using the conventional roll-to-roll type deposition apparatus described in each of Patent Documents 3 and 4.

As described above, the active material body described in Patent Document 2 is formed by carrying out the deposition for plural stages while changing the incident direction (deposition direction) of the deposition material with respect to the current collector. However, in the deposition apparatus of Patent Document 3, in the case of changing the incident direction (deposition direction) of the deposition material with respect to the current collector, the position of the deposition region with respect to the evaporation source needs to be changed. It is difficult to change the deposition direction while maintaining the vacuum state in the chamber, and it is impossible to continuously form the deposited film containing the active material bodies.

Moreover, the deposition apparatus of Patent Document 4 is not configured to carry out the oblique deposition, and it is difficult to control the incidence angle and deposition direction of the deposition material with respect to the normal direction of the surface of the current collector. Therefore, it is impossible to form the active material body grown in the zigzag manner by controlling the deposition direction of the active material body.

Further, in a case where the deposition is carried out simultaneously with the conveyance of the substrate in the conventional roll-to-roll process, the active material layer is formed on the entire surface of the substrate. This causes the problem that in order to collect the electric power, the active material layer needs to be removed from a portion where a lead is formed.

In the deposition of Patent Document 5, the deposition material is incident from two directions while causing the substrate to travel by the roll-to-roll type deposition apparatus having a V-shaped passage. Therefore, it is difficult to form a deposited film non-forming portion between film formation regions.

The deposition of Patent Document 6 does not relate to the oblique deposition and cannot switch the deposition direction with respect to the normal direction of the substrate and continuously form the active material body grown in the zigzag manner.

The present invention was made in light of the above circumstances, and an object of the present invention is to provide a roll-to-roll type deposited film forming method which is capable of continuously carrying out the oblique deposition for plural stages while changing the deposition direction with respect to the normal direction of the substrate, is capable of obtaining the deposited film non-forming portion for collecting the electric power, and excels in the mass productivity.

### Means for Solving the Problems

A deposited film forming method of the present invention is a roll-to-roll type deposited film forming method for forming a deposited film on a sheet-shaped substrate 4 such that the substrate winds around a first roll 3 and a second roll 8 so as to be conveyable in a chamber, and a deposition material is evaporated from an evaporation source 9, the method including the steps of:

(a) holding the substrate such that: between the first roll and the second roll on a conveyance passage of the substrate, a first surface of the substrate is convex with respect to the evaporation source 9 by a first guide member 6 provided in a deposition possible region to which the evaporated deposition material reaches; a first deposition possible region 60a is formed, which is located on the first roll side of the first guide member on the conveyance passage of the substrate; and a second deposition possible region 60b is formed, which is not continuous with the first deposition possible region and is located on the second roll side of the first guide member;

(b) heating the evaporation source to evaporate the deposition material;

(c) opening a shutter member 12a, 12b provided between the evaporation source and the substrate to form a first deposited film p1 on a first film formation region 30a on the first surface in the first deposition possible region 60a;

(d) after Step (c), closing the shutter member to shield the substrate from the evaporated deposition material and conveying the substrate such that the first film formation region 30a is located at the second deposition possible region 60b by unrolling the substrate by the first roll and taking up the substrate by the second roll; and

(e) after Step (d), opening the shutter member, forming the first deposited film p1 on a second film formation region 30b in the first deposition possible region 60a, the second film formation region 30b being located on the first surface and not continuous with the first film formation region 30a, and at the same time, forming a second deposited film p2 in the second deposition possible region 60b on the first deposited film p1 formed on the first film formation region 30a in Step (c), the second deposited film p2 having a different growth direction from the first deposited film p1.

Further, the deposited film forming method of the present invention further includes the steps of: (d′) after Step (e), closing the shutter member to shield the substrate from the evaporated deposition material and conveying the substrate by a substantially same distance as in Step (d) by unrolling the substrate by the first roll and taking up the substrate by the second roll; and

(e′) after Step (d′), opening the shutter member, forming the first deposited film p1 in the first deposition possible region 60a on a third film formation region 30c which is located on the first surface and not continuous with the second film formation region 30b, and at the same time, forming the second deposited film p2 in the second deposition possible region 60b on the first deposited film p1 formed on the second film formation region 30b in Step (e), the second deposited film p2 having a different growth direction from the first deposited film p1.

In accordance with the deposited film forming method of the present invention, the deposition step from different deposition directions can be continuously carried out plural times by the roll-to-roll process, and the deposited film non-forming portions can be formed.

Specifically, the guide member is provided between two rolls on the conveyance passage of the substrate and is provided in the deposition possible region to which the evaporated deposition material reaches. The substrate is held such that the surface which is exposed to the evaporated deposition material is convex with respect to the evaporation source by utilizing the guide member. With this, the first and second deposition possible regions whose deposition directions are different from each other are formed in the chamber. In the first deposition possible region, the deposition material can be incident on the surface of the substrate from a direction inclined with respect to the normal direction of the substrate. In the second deposition possible region, the deposition material can be incident on the surface of the substrate from a direction which is inclined with respect to the normal direction of the substrate and is opposite to the inclination direction in the first deposition possible region. When forming the deposited films in the deposition possible regions, the movement of the substrate stops for a certain period of time, and the shutter member provided between the evaporation source and the substrate opens. Thus, the deposition is carried out with respect to one or both of the first and second deposition possible regions. Next, the substrate is conveyed in a state where the shutter member is closed to shield both the first and second deposition possible regions from the evaporated deposition material. Again, the movement of the substrate stops for a certain period of time, and the shutter member opens. Thus, the deposition is carried out. By alternately repeating the formation of the deposited film and the conveyance of the substrate, the deposited films each obtained by alternately stacking layers having different growth directions can be continuously formed on the surface of the substrate by the roll-to-roll process while forming the deposited film non-forming portion between adjacent deposited films.

Especially, by carrying out the deposited film forming method of the present invention while maintaining a certain direction of repeated conveyance of the substrate, the deposited films each obtained by stacking two layers having different growth directions from each other can be continuously formed on the surface of the substrate having a predetermined length by the roll-to-roll process while forming the deposited film non-forming portion between adjacent deposited films.

Moreover, the deposited film forming method of the present invention can further include: (f) closing the shutter member and rewinding the substrate in a direction opposite to a direction in which the substrate is conveyed in Step (d);

(g) repeating same procedures as in Steps (c) to (e) to form a third deposited film p3 on the second deposited film p2 and form a fourth deposited film p4 on the third deposited film p3, the third deposited film p3 having a different growth direction from the second deposited film p2, the fourth deposited film p4 having a different growth direction from the third deposited film p3;

(h) repeating same procedures as in Steps (f) and (g) to obtain a deposited film including five or more layers whose growth directions are alternately different from each other. With this, the deposited films each including an arbitrary number of layers whose growth directions are alternately different from each other can be continuously formed on the surface of the substrate by the roll-to-roll process while forming the deposited film non-forming portion between adjacent deposited films.

In the present invention, in Step (a), the substrate can be held such that: between the first roll and the second roll on the conveyance passage of the substrate, the first surface is concave with respect to the evaporation source on the second roll side of the first guide member 6a by a supporting member 7 provided in the deposition possible region; and the third deposition possible region 60c is formed, which is not continuous with the second deposition possible region 60b and is located on the second roll side of the supporting member on the conveyance passage of the substrate. With this, three deposition possible regions can be provided, so that the efficiency of the deposition can be improved. Further, in Step (a), the substrate can be held such that: between the first roll and the second roll on the conveyance passage of the substrate, the first surface is convex with respect to the evaporation source on the second roll side of the supporting member 7 by the second guide member 6b provided in the deposition possible region; and the fourth deposition possible region 60d is formed, which is not continuous with the third deposition possible region 60c and is located on the second roll side of the second guide member on the conveyance passage of the substrate. With this, four deposition possible regions can be provided, so that the efficiency of the deposition can be improved.

Moreover, in the present invention, in Step (a), the substrate can be held such that: between the first roll and the second roll on the conveyance passage of the substrate, the surface exposed to the deposition material is inverted by inversion mechanisms 5b to 5e provided on the second roll side of the second deposition possible region 60b to cause the second surface opposite the first surface to face the evaporation source 9; and the third deposition possible region 60c is formed, which is not continuous with the second deposition possible region 60b and is located on the second roll side of the inversion mechanisms on the conveyance passage of the substrate. With this, the deposited film can be formed on each of both surfaces of the substrate. Further, in Step (a), the substrate can be held such that: between the first roll and the second roll on the conveyance passage of the substrate, the second surface is convex with respect to the evaporation source 9 on the second roll side of the third deposition possible region 60c by the second guide member 6b provided in the deposition possible region; and the fourth deposition possible region 60d is formed, which is not continuous with the third deposition possible region 60c and is located on the second roll side of the second guide member on the conveyance passage of the substrate. With this, the deposition step from different deposition directions can be continuously carried out plural times by the roll-to-roll process with respect to both surfaces of the substrate, and the deposited film non-forming portion can be formed.

Therefore, in accordance with the deposited film forming method of the present invention, a plurality of active material bodies can be caused to grow on the surface of the substrate in a zigzag manner. Therefore, it is possible to manufacture an electrode in which the expansion stress of the active material is more effectively buffered than an electrode manufactured using the conventional deposition apparatus described in Patent Documents 3 to 6. Moreover, in accordance with the deposited film forming method of the present invention, the above-described active material body can be continuously formed on the surface of the sheet-shaped substrate by the roll-to-roll process. Therefore, it is possible to realize a process which is more excellent in mass productivity than a process which controls the deposition direction by switching the inclination direction of a base for fixing the current collector as described in Patent Document 2.

Further, in accordance with the deposited film forming method of the present invention, the deposited film is formed in a state where the substrate stops, and after the formation of the deposited film, the shutter is closed, and the substrate is conveyed. Therefore, the deposited films are not continuous with one another in the longitudinal direction of the substrate. To be specific, the deposited film non-forming portion extending perpendicular to the longitudinal direction can be formed on the surface of the sheet-shaped substrate.

Further, the present invention also relates to a battery polar plate including: a sheet-shaped substrate; and a deposited film including a plural-layer-structure active material body having four or more layers stacked on the substrate, wherein: a growth direction of the active material body is inclined with respect to a normal direction of the substrate; adjacent two layers in the plural-layer-structure active material body are different from each other in the growth direction of the active material body; and a (3z+1)-th layer is twice as thick as each of a 3z-th layer and a (3z−1)-th layer (z is an integer of 1 or more).

### EFFECTS OF THE INVENTION

In accordance with the present invention, on the substrate passage defined to be convex with respect to the evaporation source by the first guide member, the deposition possible regions having different deposition directions can be respectively formed on both sides of the first guide member. Therefore, the present invention can provide the deposited film forming method capable of continuously carrying out a plurality of deposition steps having different deposition directions from one another and having excellent mass productivity. Moreover, it is possible to form the deposited film non-forming portion used as a collected power outlet.

In accordance with the deposited film forming method of the present invention, it is possible to manufacture the electrode having excellent charge-discharge cycle characteristic by a process realizing excellent productivity.

### BRIEF DESCRIPTION OF THE DRAWINGS

FIG. 1 is a schematic cross-sectional view of a deposition apparatus of Embodiment 1 of the present invention.

FIG. 2 is a cross-sectional view for explaining an angle (incidence angle) at which the deposition material is incident on the substrate in the deposition apparatus of Embodiment 1 of the present invention.

FIG. 3 is a schematic cross-sectional view of the active material body (the number n of layers=2) formed using the deposition apparatus of Embodiment 1 of the present invention.

FIG. 4 is a schematic cross-sectional view of the active material body (the number n of layers=4) formed using the deposition apparatus of Embodiment 1 of the present invention.

FIG. 5 is a conceptual diagram showing the thickness of a two-layer active material body formed by the present invention.

FIG. 6 is a schematic cross-sectional view of the deposition apparatus of Embodiment 2 of the present invention.

FIG. 7 is a schematic cross-sectional view of the deposition apparatus of Embodiment 3 of the present invention.

FIG. 8 is a schematic cross-sectional view of the active material body (the number n of layers=2) formed using the deposition apparatus of Embodiment 3 of the present invention.

FIG. 9 is a schematic cross-sectional view of the deposition apparatus of Embodiment 4 of the present invention.

FIG. 10 is a schematic cross-sectional view of the active material body (the number n of layers=8) formed using the deposition apparatus of Embodiment 4 of the present invention.

FIG. 11 is a top view of the substrate having a surface on which a deposited film is formed using the deposition apparatus of Embodiment 1 of the present invention.

FIG. 12 is a flow chart showing respective steps of one mode of a deposited film forming method according to Embodiment 1 of the present invention.

FIG. 13 is a schematic cross-sectional view of a plural-layer-structure active material body formed by a method B of Embodiment 1 of the present invention.

### EXPLANATION OF REFERENCE NUMBERS

1 vacuum pump
2 chamber
3, 8 winder or unwinder
4 substrate
5a to 5k feed roller
6, 6a to 6d guide member
7, 7a to 7b supporting member
9 evaporation source
9s evaporation surface
10a, 10b shielding plate
11a, 11b gas introduction tube
12a to 12d shutter
13 measuring device
15a to 15e shielding plate
16a to 16d heater portion
20, 20a to 20d shielding member
22 nozzle portion
24 nozzle portion shielding plate
28 shutter
30a to 30d film formation region
31a to 31c deposited film non-forming portion
60a to 60h deposition possible region
70, 70a to 70f deposition impossible region
100, 200, 300, 400 deposition apparatus

### BEST MODE FOR CARRYING OUT THE INVENTION

Hereinafter, embodiments regarding a deposited film forming method according to the present invention and a deposition apparatus used in this method will be explained in reference to the drawings.

### Embodiment 1

### Embodiment of One Surface in V

In the deposition apparatus of the present embodiment, a sheet-shaped substrate is conveyed in a chamber so as to be convex with respect to an evaporation source, and deposition is carried out in regions respectively located on both sides of a top portion of the convex. To be specific, the deposition apparatus of the present embodiment includes a V-shaped substrate passage (V-shaped passage).

Configuration of Deposition Apparatus

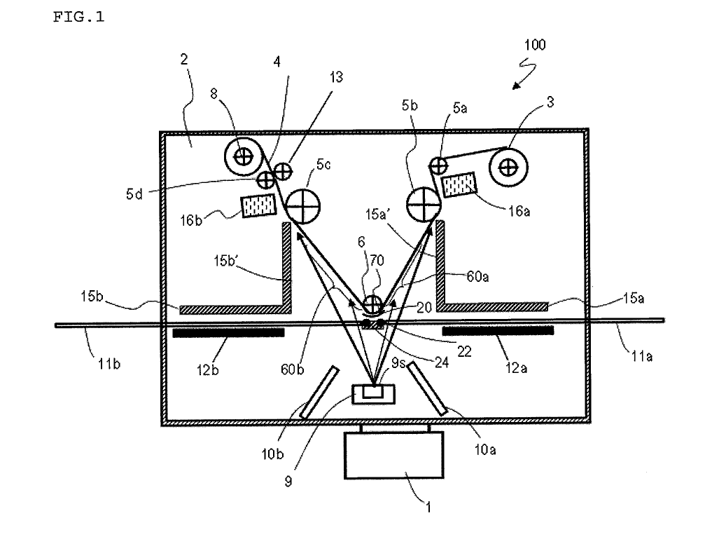

First, FIG. 1 is referred. FIG. 1 is a cross-sectional view schematically showing the deposition apparatus of Embodiment 1 of the present invention. A deposition apparatus 100 includes: a chamber (vacuum chamber) 2; a vacuum pump 1 provided outside the chamber 2 and configured to discharge a gas from the chamber 2; and gas introduction tubes 11a and 11b through which the gas, such as an oxygen gas, is introduced from outside the chamber 2 to the chamber 2. Provided inside the chamber 2 are an evaporation source 9 configured to evaporate a deposition material, a conveying portion configured to convey a sheet-shaped substrate 4, a shielding portion configured to form a shielded region to which the deposition material evaporated by the evaporation source 9 does not reach, movable shutters 12a and 12b configured to shield the substrate from the deposition material evaporated by the evaporation source 9, heater portions 16a and 16b configured to heat the substrate 4, and a nozzle portion 22 connected to the gas introduction tubes 11a and 11b and configured to supply the gas to the surface of the substrate 4.

The evaporation source 9 includes a container, such as a crucible, configured to store the deposition material and a heating device configured to evaporate the deposition material. The evaporation source 9 is configured such that the deposition material and the container are suitably detachable. Examples of the heating device are a resistance heating device, an induction heating device, and an electron beam heating device. When carrying out the deposition, the deposition material stored in the crucible is heated by the heating device to evaporate from an upper surface (evaporation source) 9s thereof. Thus, the deposition material is supplied to the surface of the substrate 4.

The conveying portion includes first and second rolls 3 and 8 each configured to take up and hold the substrate 4 and a guiding portion configured to guide the substrate 4. The guiding portion includes a first guide member (herein, a feed roller) 6 and feed rollers 5a to 5d. With this, a conveyance passage of the substrate 4 is defined such that the substrate 4 passes through a region (deposition possible region) to which the deposition material evaporated from the evaporation surface 9s reaches. A measuring device 13 can measure the amount of rotation of the feed roller (herein, the feed roller 5d) rotating for the conveyance of the substrate 4 to measure a travel distance of the substrate 4.

Each of the first and second rolls 3 and 8, the feed rollers 5a to 5d, and the first guide member 6 has, for example, a cylindrical shape having a length of 600 mm. The first and second rolls 3 and 8, the feed rollers 5a to 5d, and the first guide member 6 are arranged in the chamber such that length directions (that is, a width direction of the substrate 4) thereof are parallel to one another. FIG. 1 shows only a cross section parallel to the bottom surface of each cylindrical shape.

The evaporation source 9 may be configured such that, for example, the evaporation surface 9s of the deposition material has an adequate length (for example, 600 mm or more) in a direction parallel to the width direction of the substrate 4 conveyed by the conveying portion. With this, the deposition can be carried out substantially uniformly in the width direction of the substrate 4. The evaporation source 9 may be configured to include a plurality of crucibles arranged along the width direction of the substrate 4 being conveyed.

In the present embodiment, the first roll 3 unrolls the substrate 4, the feed rollers 5a to 5d and the first guide member 6 guide the unrolled substrate 4 along the conveyance passage, and the second roll 8 takes up the substrate 4. The taken-up substrate 4 is again unrolled by the second roll 8 according to need and is conveyed in the opposite direction along the conveyance passage. As above, each of the first and second rolls 3 and 8 in the present embodiment can serve as a winder and a unwinder depending on a conveyance direction. Moreover, since the number of times the substrate 4 passes through the deposition possible region can be adjusted by repeatedly reversing the conveyance direction, the deposition step can be continuously carried out a desired number of times.

The feed rollers 5a and 5b, the first guide member 6, and the feed rollers 5c and 5d are arranged in this order from a first roll side on the conveyance passage of the substrate 4. In the present specification, the “first roll side on the conveyance passage of the substrate 4” denotes the first roll side on the conveyance passage having both ends on which the first and second rolls 3 and 8 are respectively disposed, regardless of the conveyance direction of the substrate 4 and the spatial arrangement of the first roll. Moreover, the first guide member 6 is provided lower than the adjacent feed rollers 5b and 5c. The first guide member 6 holds the substrate 4 such that a surface of the substrate 4 which surface is exposed to the deposition material is convex with respect to the evaporation source 9 (to be specific, the surface of the substrate projects toward the evaporation source 9). With this configuration, in the cross-sectional view, the passage of the substrate 4 has a V shape or a U shape such that the substrate 4 turns around at the feed roller 6. In the present specification, the V-shaped or U-shaped passage defined by the first guide member 6 is called a “V-shaped passage”.

A first shielding member 20 is provided between the first guide member 6 and the evaporation source 9 (evaporation surface 9s). With this, the deposition material evaporated from the evaporation surface 9s is prevented from being incident from the normal direction of the substrate 4, and only the oblique deposition can be carried out. In addition, a deposition impossible region 70 which divides the deposition possible region of the V-shaped passage into two regions can be formed. With this configuration, a first deposition possible region 60a and a second deposition possible region 60b are formed. The first deposition possible region 60a is located on the first roll side of the first guide member 6 on the conveyance passage of the substrate 4, and the second deposition possible region 60b is located on a second roll side of the first guide member 6 on the conveyance passage of the substrate 4. In the present specification, the names of the deposition possible regions do not relate to the positions of the first and second rolls 3 and 8 in the chamber 2 and the conveyance direction of the substrate 4. On the V-shaped passage defined by the first guide member 6, a region located on the first roll side of the first guide member 6 is referred to as “the first deposition possible region 60a”, and a region located on the second roll side of the first guide member 6 is referred to as “the second deposition possible region 60b”. Therefore, “the first deposition possible region 60a” may be located on the first roll side of the first guide member 6 on the conveyance passage of the substrate 4. For example, a straight-line distance between the first roll 3 and the first deposition possible region 60a may be longer than a straight-line distance between the first roll 3 and the first guide member 6.

The shielding portion is provided in the deposition possible region. In addition to the above-described first shielding member 20, the shielding portion includes: shielding plates 10a and 10b provided to cover the evaporation source 9 and an exhaust port (not shown) connected to the vacuum pump 1; a nozzle portion shielding plate 24 provided to cover the nozzle portion 22; and shielding plates 15a and 15b each extending from a side wall of the chamber 2 toward an upper end portion of the first deposition possible region 60a or an upper end portion of the second deposition possible region 60b. The shielding plates 15a and 15b are provided to cover the substrate 4 traveling the deposition possible region other than the deposition possible regions 60a and 60b on the conveyance passage of the substrate 4, the first and second rolls 3 and 8, the heater portions 16a and 16b, and the like. Thus, the shielding plates 15a and 15b prevent the deposition material from reaching the deposition possible region other than the deposition possible regions 60a and 60b, the first and second rolls 3 and 8, the heater portions 16a and 16b, and the like. Moreover, the shielding plate 15a includes a wall portion 15a′ facing the deposition possible region 60a, and the shielding plate 15b includes a wall portion 15b′ facing the deposition possible region 60b. By these wall portions, the gas emitted from a plurality of emission ports provided on a side surface of the nozzle portion 22 can be effectively retained in the deposition possible regions 60a and 60b.

The conveying portion and the shielding portion in the present embodiment are provided with respect to the evaporation source 9 such that the deposition material evaporated from the evaporation surface 9s is not incident on the substrate 4 from the normal direction of the substrate 4, the substrate 4 being traveling along the conveyance passage. With this, the deposition (oblique deposition) can be carried out from a direction inclined with respect to the normal direction of the substrate 4. In the deposition apparatus 100 shown in FIG. 1, by the first shielding member 20 and the nozzle portion shielding plate 24, the deposition material is prevented from being incident on the substrate 4 from the normal direction of the substrate 4. However, depending on the configuration of the conveying portion, the other shielding plate (for example, 15a and 15b) may perform in the same manner as above.

The shutters 12a and 12b can be moved such that the deposition material evaporated from the evaporation surface 9s is prevented from reaching “the first deposition possible region 60a” or “the second deposition possible region 60b” or is allowed to reach “the first deposition possible region 60a” or “the second deposition possible region 60b”.

The nozzle portion 22 of the present embodiment is provided between the shielding plate 15a and the first guide member 6. The nozzle portion 22 is, for example, a tube extending along the width direction (direction perpendicular to the cross section shown in FIG. 1) of the substrate 4 being conveyed. A plurality of emission ports configured to eject the gas to the corresponding deposition possible regions 60a and 60b are provided on the side surface of the nozzle portion 22. With this, in the first and second deposition possible regions 60a and 60b, the gas can be supplied substantially uniformly in the width direction of the substrate 4. Moreover, it is preferable that the nozzle portion 22 be configured to eject the gas parallel to each of the first and second deposition possible regions 60a and 60b. With this configuration, a reaction rate between the oxygen gas ejected from the nozzle portion 22 and deposition particles can be increased, and the deposited film having high degree of oxidation can be formed without deteriorating vacuum pressure in the chamber 2.

The heater portions 16a and 16b are respectively provided on the first roll side and the second roll side on the V-shaped passage. With this configuration, the substrate 4 can be heated before holding the substrate 4 in a below-described substrate holding step 501. With this, organic substances (for example, a rolling lubricating oil component (such as fatty acid ester, alcohol, or fatty acid) used when forming a concave-convex pattern of the surface of a metal foil) adhered to the surface of the substrate 4 are removed. Thus, the adhesion between the substrate 4 and the deposition material (such as the silicon particles) and the adhesion between the deposition materials (silicon particles) can be improved. A heating temperature of the substrate 4 is determined such that the strength of the substrate 4 does not excessively decrease. Therefore, the heating temperature of the substrate 4 is preferably about 200 to 400° C. depending on the material of the substrate 4. Specifically, in a case where the substrate 4 is conveyed from the first roll 3 to the V-shaped passage, the substrate 4 is heated by the heater portion 16a to 200 to 400° C. (for example, 300° C.) before the substrate 4 passes through the V-shaped passage. In contrast, in a case where the substrate 4 is conveyed from the second roll 8 to the V-shaped passage, the substrate 4 is heated by the heater portion 16b to 200 to 400° C. (for example, 300° C.) before the substrate 4 passes through the V-shaped passage. Here, the substrate 4 is heated only when carrying out the deposition on a surface which is not yet subjected to the deposition, and the substrate 4 is not heated when carrying out the deposition on a surface which has already been subjected to the deposition once.

Here, used as the material of the substrate 4 when manufacturing the electrode of the lithium-ion secondary battery is the metal foil, such as aluminum foil, copper foil, or nickel foil, capable of collecting the electric power.

Operations of Deposition Apparatus

Next, the operations of the deposition apparatus 100 will be explained. The following will explain an example in which a plurality of active material bodies containing the silicon oxide are formed on the surface of the substrate 4 using the deposition apparatus 100.

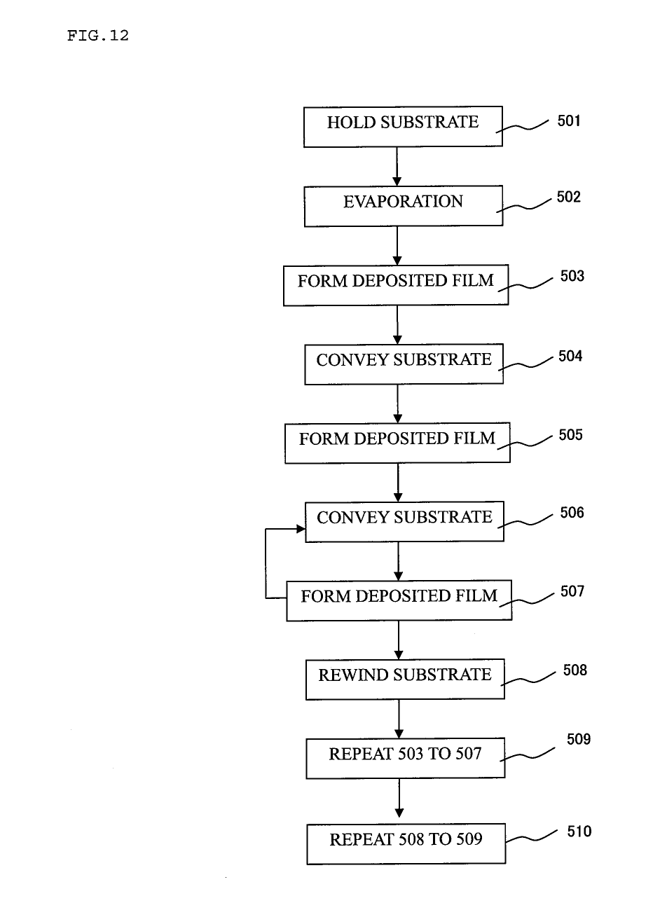

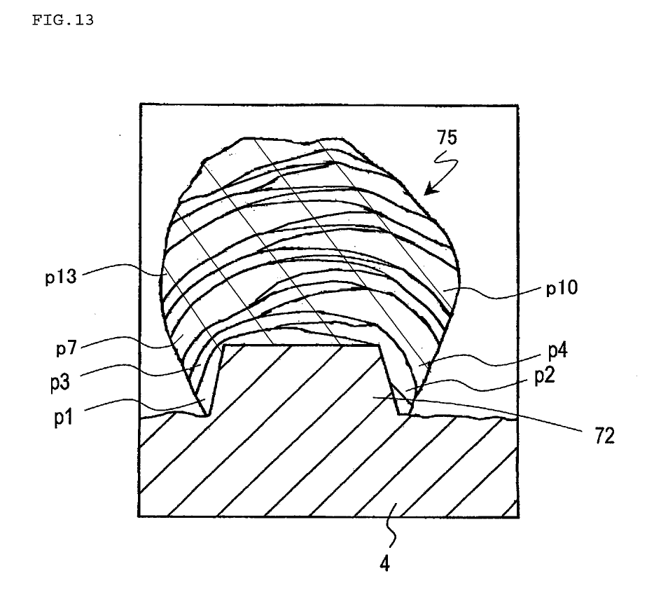

A method A that is one mode of the operation of the deposition apparatus 100 will be explained in reference to FIG. 12.

In the method A, first, the substrate holding step 501 is carried out as Step (a). To be specific, the elongated substrate 4 is wound around the first roll 3. As the substrate 4, the metal foil, such as the aluminum foil, the copper foil, or the nickel foil, can be used. As will be described below, in order to form a plurality of active material bodies on the surface of the substrate 4 at predetermined intervals, the shadowing effect obtained by the oblique deposition needs to be utilized. Therefore, it is preferable that the concave-convex pattern be formed on the surface of the metal foil. In the present embodiment, used as the concave-convex pattern is, for example, a pattern in which projections are regularly arranged. Each of the projection has a quadrangular prism shape having a rhombic upper surface (diagonal lines: 20 μm×10 μm) and a height of 10 μm. An interval along a longer diagonal line of the rhombic shape is set to 20 μm, an interval along a shorter diagonal line thereof is set to 10 μm, and an interval in a direction parallel to a side of the rhombic shape is set to 10 μm. Moreover, a surface roughness Ra of the upper surface of each projection is set to, for example, 2.0 μm.

Moreover, the deposition material (such as silicon) is stored in the crucible of the evaporation source 9, and each of the gas introduction tubes 11a and 11b is connected to, for example, an oxygen gas bomb provided outside the deposition apparatus 100. In this state, the gas is discharged from the chamber 2 using the vacuum pump 1.

Next, the shutters 12a and 12b are closed such that the deposition material does not reach the first and second deposition possible regions 60a and 60b. Next, the substrate 4 winding around the first roll 3 is unrolled, passes through the first guide member 6, and is conveyed to the second roll 8 while forming the V-shaped passage. After the substrate 4 is first heated to 200 to 300° C. by the heater portion 16a, it travels to the first and second deposition possible regions 60a and 60b and stops.

Next, an evaporating step 502 is carried out as Step (b). To be specific, the silicon in the crucible of the evaporation source 9 is evaporated by the heating device (not shown), such as an electron beam heating device. The evaporation of the silicon is not terminated before starting Step (c) but always continues at the stage for forming the deposited film.

A deposited film forming step 503 is carried out as Step (c). To be specific, only the shutter 12a opens, and the silicon evaporated in Step (b) is supplied to the surface of the substrate 4 located in the first deposition possible region 60a. Simultaneously, the oxygen gas is supplied from the nozzle portion 22 through the gas introduction tube 11a to the surface of the substrate 4. In the step of forming the deposited film, the substrate 4 is not traveling. With this, compounds (silicon oxide) containing the silicon and the oxygen can be grown on the surface of the substrate 4 by reactive deposition. Thus, a first layer is formed on a deposition region 30a of the surface of the substrate in the first deposition possible region 60a (first deposited film forming step).

After Step (c), a substrate conveying step 504 is carried out as Step (d). To be specific, after the deposition is carried out with respect to the substrate 4 for a predetermined period of time in Step (c), the shutter 12a is closed to stop supplying the silicon to the substrate 4. In this closed state, next, the substrate 4 winding around the first roll 3 is unrolled and conveyed to the second roll 8. The conveyance direction from the first roll 3 to the second roll 8 is hereinafter referred to as a “forward direction”. The measuring device 13 adjusts a conveyance distance, so that the conveyance of the substrate stops when the portion (the first film formation region 30a) subjected to the deposition in the first deposition possible region 60a has reached the second deposition possible region 60b. The substrate is conveyed in Step (d) such that the region located in the first deposition possible region 60a in Step (c) and having the surface on which the deposited film is formed is located in the second deposition possible region 60b. With this, the deposition can be effectively carried out while alternately switching between two different deposition directions.

Then, by alternately repeating the deposited film forming step and the substrate conveying step, the deposited film can be formed, in which deposited layers whose growth directions are alternately different from each other are stacked.

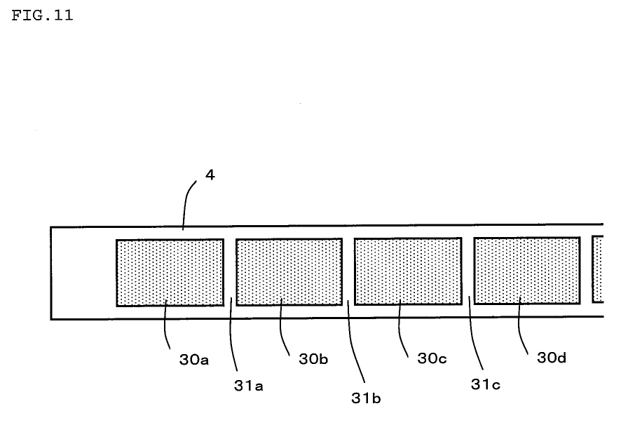

First, after Step (d), a second deposited film forming step 505 is carried out as Step (e). To be specific, the shutters 12a and 12b open, and the evaporated silicon is supplied to the surface of the substrate 4 located in the first and second deposition possible regions 60a and 60b. Simultaneously, the oxygen gas is supplied from the nozzle portion 22 through the gas introduction tubes 11a and 11b to the surface of the substrate 4. With this, in the second deposition possible region 60b, a second layer is formed on the first layer which has already been formed on the surface of the first film formation region 30a. In addition, in the first deposition possible region 60a, the first layer is formed on the surface of a second film formation region 30b. Since there exists the deposition impossible region 70, the first film formation region 30a and the second film formation region 30b sandwich the deposited film non-forming portion 31a as shown in FIG. 11 and are not continuously formed.

After Step (e), a second substrate conveying step 506 is carried out as Step (d′). To be specific, after the deposition is carried out with respect to the substrate 4 for a predetermined period of time in Step (e), the shutters 12a and 12b are closed to stop supplying the silicon to the substrate 4. Next, the substrate 4 is conveyed in the forward direction while adjusting the conveyance distance by the measuring device 13. Then, the substrate 4 stops when the portion subjected to the deposition in the first deposition possible region 60a has reached the second deposition possible region 60b.

After Step (d′), a third deposited film forming step 507 is carried out as Step (e′). To be specific, as with the second deposited film forming step, the shutters 12a and 12b open, and the deposition is carried out with respect to both the first and second deposition possible regions 60a and 60b. With this, in the second deposition possible region 60b, the second layer is formed on the first layer which has already been formed on the surface of the second film formation region 30b. In addition, in the first deposition possible region 60a, the first layer is formed on the surface of a third film formation region 30c.

Further, the same procedure as in Step (d′) is carried out. To be specific, as with the second substrate conveying step, the shutters 12a and 12b are closed, and the substrate 4 is conveyed in the forward direction. Then, the substrate 4 stops when the portion subjected to the deposition in the first deposition possible region 60a has reached the second deposition possible region 60b.

As above, the deposited film forming step carried out with the shutters 12a and 12b open and the substrate conveying step carried out in a certain direction with the shutters 12a and 12b closed are alternately carried out until the substrate 4 of a predetermined length is unrolled. With this, the deposited films each including a two-layer-structure active material body are formed on predetermined regions of the substrate 4 while providing the deposited film non-forming portions each located between the deposited films (first traveling step). In the last deposited film forming step in the first traveling step, only the shutter 12b opens, and the deposition is carried out only with respect to the second deposition possible region 60b.

The foregoing has explained a case where the deposition is carried out only in the first deposition possible region 60a in the first deposited film forming step, and the deposition is carried out only in the second deposition possible region 60b in the last deposited film forming step. This is preferable since only the deposited films each including a desired number of layers are formed on desired regions of the substrate 4, and wasteful deposition is not carried out. However, in order to further facilitate the control of the operations of the shutters, the shutters 12a and 12b may open in all the deposited film forming steps, and the deposition may be carried out with respect to both the first and second deposition possible regions 60a and 60b in all the deposited film forming steps. In this case, the film formation region where a desired number of layers are not formed may be discarded.

After the formation of the deposited films in predetermined regions is terminated as above, a substrate rewinding step 508 is carried out as Step (f). To be specific, after the substrate 4 of a predetermined length is unrolled in Step (d′), and the deposition is terminated in Step (e′), the shutters 12a and 12b are closed, and the substrate 4 winding around the second roll 8 is rewound to the first roll 3. To be specific, the substrate 4 is rewound in a direction opposite the direction in which the substrate 4 is wound in Step (d). With this, the substrate 4 is rewound to the same position as in Step (a). The conveyance direction from the second roll 8 to the first roll 3 is hereinafter referred to as an “opposite direction”.

Next, Step 509 in which the same procedures as in the deposited film forming step 503 to the deposited film forming step 507 are carried out is carried out as Step (g). Specifically, the deposited film forming step carried out with the shutters 12a and 12b open in accordance with the above-explained order and the substrate conveying step carried out in a certain direction with the shutters 12a and 12b closed are alternately repeated until the substrate 4 of the same length as in the first traveling step is unrolled. With this, a third layer and a fourth layer are formed on the two-layer structure obtained above. To be specific, the deposited films each including a four-layer-structure active material body are formed on predetermined regions of the substrate 4 in Step (g) (second traveling step).

At last, Step 510 in which the same procedures as in Steps (f) and (g) are alternately repeated an arbitrary number of times is carried out as Step (h). With this, the deposited films each including the active material body having an arbitrary number n of layers can be formed on predetermined regions of the substrate 4. Here, the number n of layers is twice the number of times of the traveling step.

FIG. 11 is a diagram showing the surface of the substrate on which the deposited films are formed, when viewed from above. Since the evaporated deposition material is not incident from the normal direction of the substrate 4 by the first shielding member 20, the deposited film is not continuously formed at a portion shielded by the first shielding member 20. To be specific, the film formation regions 30a, 30b, 30c, and 30d on each of which the deposited film is formed are separated from one another by the deposited film non-forming portions 31a, 31b, and 31c each formed perpendicular to a longitudinal direction of the substrate 4.

The following will explain a relation between the film formation regions 30a, 30b, 30c, and 30d of FIG. 11 and the deposited film forming step carried out plural times. In the first deposited film forming step 503, the first layer is formed on the film formation region 30a. In the second deposited film forming step 505, the second layer is formed on the film formation region 30a, and the first layer is formed on the film formation region 30b. In the third deposited film forming step 507, the second layer is formed on the film formation region 30b, and the first layer is formed on the film formation region 30c. In the fourth deposited film forming step, the second layer is formed on the film formation region 30c, and the first layer is formed on the film formation region 30d. By further repeating the same operations as above, the deposited films each including the two-layer-structure active material body can be formed on the substrate 4 of an arbitrary length by a continuous process.

Here, an angle (incidence angle) θ at which the deposition material is incident on the substrate 4 in each of the first and second deposition possible regions 60a and 60b will be explained in reference to FIG. 2. Herein, the “incidence angle θ” denotes an angle formed between a normal line of the substrate 4 and the incident direction of the deposition material.

FIG. 2 is a cross-sectional view schematically showing a positional relation among the first and second deposition possible regions 60a and 60b and the evaporation source 9 in the chamber 2. For simplicity, the same reference numbers are used for the same components as in FIG. 1, and explanations thereof are omitted.

As shown in FIG. 2, the first and second deposition possible regions 60a and 60b are provided on both sides of the first guide member 6 on the above-described V-shaped passage. At this time, the incidence angle θ of the deposition material in the first deposition possible region 60a is equal to or larger than an incidence angle θ2 of the deposition material on a lower end portion (end portion on the first guide member 6 side) 62L of the first deposition possible region 60a. Further, the incidence angle θ is equal to or smaller than an incidence angle θ1 of the deposition material on an upper end portion 62U of the first deposition possible region 60a. The incidence angle θ1 on the upper end portion 62U is an angle formed between a straight line 32 perpendicular to the first deposition possible region 60a and a straight line 30 connecting the upper end portion 62U of the first deposition possible region 60a and the center of the evaporation surface 9s. Moreover, the incidence angle θ2 on the lower end portion 62L is an angle formed between a straight line 36 perpendicular to the first deposition possible region 60a and a straight line 34 connecting the lower end portion 62L of the first deposition possible region 60a and the center of the evaporation surface 9s. Similarly, the incidence angle θ of the deposition material in the second deposition possible region 60b is equal to or larger than an incidence angle θ3 of the deposition material on a lower end portion 64L of the second deposition possible region 60b and is equal to or smaller than an incidence angle θ4 of the deposition material on an upper end portion 64U of the second deposition possible region 60b.

In the present embodiment, it is preferable that the first guide member 6, the feed rollers 5b and 5c, the shielding plates 15a and 15b, the shielding member 20, and the nozzle portion shielding plate 24 be provided with respect to the evaporation source 9 such that each of the incidence angles θ1 to θ4 be not smaller than 45° and not larger than 75° (preferably not smaller than 60° and not larger than 75°). The reason for this will be explained below.

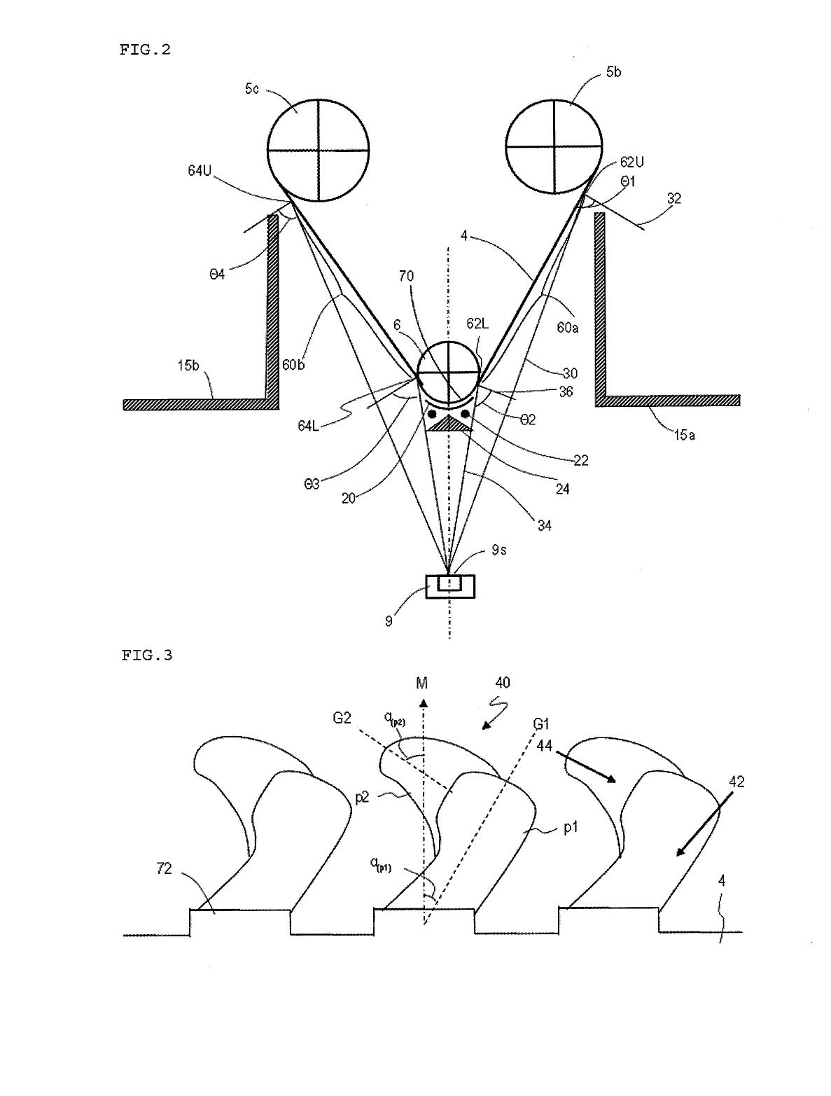

In a case where each of the incidence angles θ1 to θ4 is controlled to be not smaller than 45° and not larger than 75°, the incidence angle θ of the silicon in each of the first and second deposition possible regions 60a and 60b is in a range of not smaller than 45° and not larger than 75°. In a case where the incidence angle θ of the silicon is smaller than 45°, it is difficult to cause the silicon to be incident only on the projections 72 (shown in FIG. 3) of the substrate 4 by utilizing the shadowing effect, and there is a possibility that an adequate gap cannot be formed between the active material bodies. Therefore, in the case of applying such substrate 4 to a negative electrode of the lithium-ion secondary battery, the substrate 4 tends to wrinkle by the expansion of each active material body when charging the lithium-ion secondary battery. In contrast, in a case where the incidence angle θ is larger than 75°, the growth direction of the active material body is significantly inclined toward the surface of the substrate. Therefore, the adhesion between the surface of the substrate 4 and the active material body becomes low, and the adhesion between the substrate 4 and the active material body deteriorates. On this account, in the case of applying such substrate 4 to the negative electrode of the lithium-ion secondary battery, the active material body tends to come off from the substrate 4 by charging and discharging the lithium-ion secondary battery.

Moreover, the incident direction of the deposition material in the first deposition possible region 60a and the incident direction of the deposition material in the second deposition possible region 60b are inclined oppositely while sandwiching the normal direction of the substrate 4. With this, it is possible to grow the active material body in directions which are inclined oppositely with respect to the normal direction of the substrate 4. Therefore, the above-described zigzag active material body can be obtained. Moreover, the deposited film formed in the second deposition possible region overlaps the deposited film formed in the first deposition possible region. Therefore, it is preferable that the first deposition possible region and the second deposition possible region be the same in length as each other. In FIG. 2, the incidence angles θ1 to θ4 are respectively 75°, 60°, 60°, and 75° (θ1=75°, θ2=60°, θ3=60°, θ4=75°.

Hereinafter, the step of forming the deposited film in each of the first and second deposition possible regions 60a and 60b will be explained in detail in reference to the drawings. The following will explain, as an example, a step in which the silicon is used as the deposition material, the deposition is carried out while supplying the oxygen from the nozzle portion 22, and a silicon oxide film (SiOx, 0<x<2) is formed as the deposited film.

FIG. 3 is a diagram schematically showing one example of the deposited film (silicon oxide film) including the two-layer active material body and is a cross-sectional view perpendicular to the substrate 4 and including the incident direction (deposition direction) of the silicon. Such deposited film can be obtained by carrying out the traveling step once.

First, the silicon is incident on the surface of the substrate 4 in the first deposition possible region 60a from a direction 42 which is inclined by an angle of not smaller than 60° and not larger than 75° with respect to a normal direction M of the substrate 4. At this time, the silicon is easily deposited on the projections 72 arranged on the surface of the substrate 4. Therefore, the silicon oxide grows in a columnar shape on the projection 72. In contrast, on the surface of the substrate 4, a region is formed, which falls under shadow of the projection 72 and the silicon oxide growing in the columnar shape and on which Si atoms are not incident and the silicon oxide is not deposited (shadowing effect). In the example shown in FIG. 3, by such shadowing effect, the Si atoms are not adhered to grooves each formed between adjacent projections 72 on the surface of the substrate 4, so that the silicon oxide does not grow on the groove. As a result, the silicon oxide selectively grows in the columnar shape on each projection 72 of the substrate 4. Thus, a first portion p1 is obtained (formation of the first layer). The first portion p1 is obtained in the first deposited film forming step in the first traveling step. A growth direction G1 of the first portion p1 is inclined at an angle α (p1) with respect to the normal direction M of the substrate 4.

Then, the substrate 4 is conveyed such that the first film formation region 30a reaches the second deposition possible region 60b. In the second deposition possible region 60b, the silicon is incident on the surface of the substrate 4 from a direction 44 which is inclined opposite the direction 42 by an angle of not smaller than 60° and not larger than 75° with respect to the normal direction M of the substrate 4. At this time, by the above-described shadowing effect, the silicon is selectively incident on the first portion p1 formed on the substrate 4. Therefore, the second portion p2 having a growth direction G2 inclined with respect to the normal direction M of the substrate 4 is formed on the first portion p1 (formation of the second layer). The second layer is formed in the second deposited film forming step in the first traveling step.

Thus, a two-layer active material body (the number n of layers=2) 40 including two portions which are different from each other in the growth direction is formed. Respective active material bodies 40 are arranged to correspond to the projections 72 formed on the surface of the substrate 4. Therefore, an adequate gap can be secured between adjacent active material bodies. On this account, it is possible to suppress problems, such as the deformation of the electrode due to the expansion stress of the active material body 40.

FIG. 5 is a conceptual diagram showing the thickness of the two-layer active material body formed as above. Here, the first portions p1 in a front region located on a front side in the conveyance direction of the substrate are thicker, and the second portions p2 in a rear region located on a rear side in the conveyance direction of the substrate are thicker. This is because a film formation rate is higher at a position closer to the evaporation source 9. To be specific, this is because in the first deposition possible region 60a in which the first portion p1 is formed, the front region is closer to the evaporation source, and in the second deposition possible region 60b in which the second portion p2 is formed, the rear region is closer to the evaporation source 9.

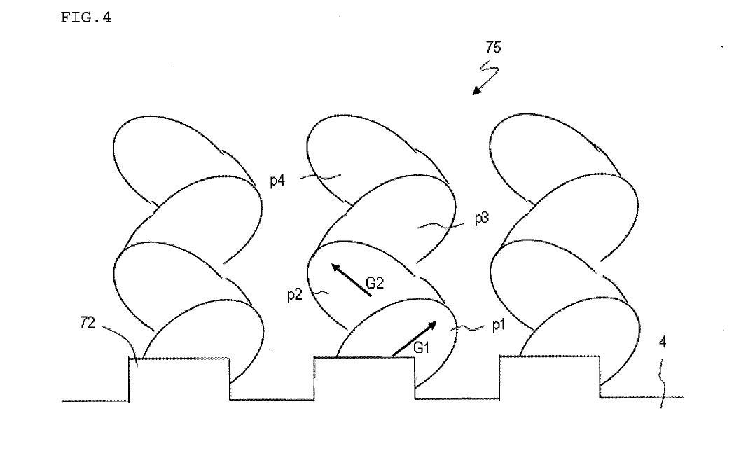

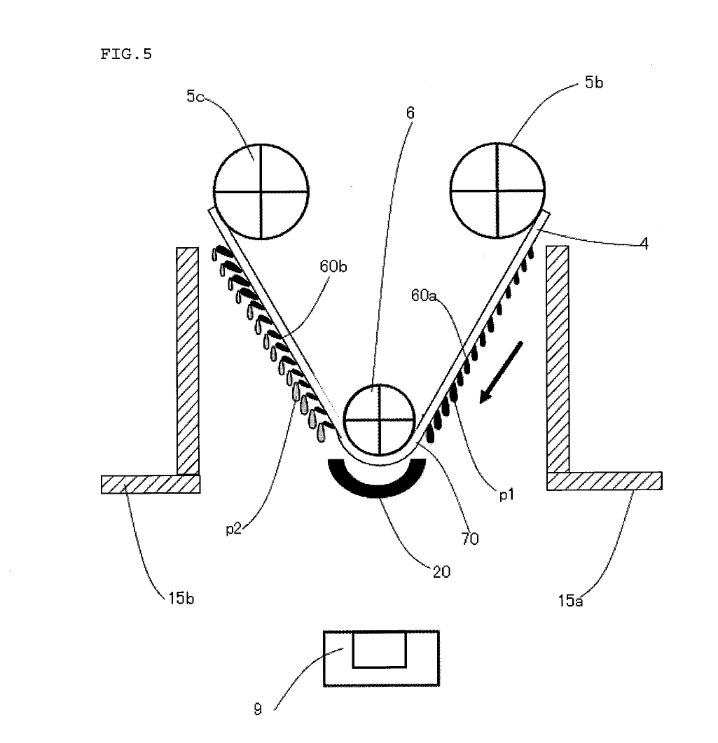

FIG. 4 is a cross-sectional view showing the deposited film including the four-layer (the number n of layers=4) active material body formed using the deposition apparatus 100. Such deposited film can be obtained by carrying out the traveling step twice.

Specifically, after the first traveling step explained in reference to FIG. 3, the substrate is rewound in Step (f), and the second traveling step is carried out. In the second traveling step, the silicon atoms are again incident from the direction 42 in the first deposition possible region 60a. Therefore, the silicon oxide further grows on the second portion p2 in a direction that is substantially the same as the growth direction G1 of the first portion p1 to form a third portion p3 (formation of the third layer). The third layer is formed in the first deposited film forming step in the second traveling step.

Next, the substrate 4 is conveyed such that the first film formation region 30a reaches the second deposition possible region 60b. Then, a fourth portion p4 growing in a direction parallel to the growth direction G2 of the second portion p2 is formed on the third portion p3 in the second deposition possible region 60b (formation of the fourth layer). The fourth layer is formed in the second deposited film forming step in the second traveling step. Thus, an active material body (the number n of layers=4) 75 can be obtained.

In the present embodiment, it is preferable that the length and position of each of the deposition possible regions 60a and 60b be adjusted such that a ratio of the length of the first deposition possible region 60a to the length of the second deposition possible region 60b becomes substantially 1:1. The length of the deposition possible region denotes a width of the deposition possible region in the longitudinal direction of the substrate 4. In a case where the above ratio becomes far from 1:1, problems occur, that is, the region of the stacked active materials decreases, and a charging capacity per unit area decreases. In contrast, in a case where the conveying portion is arranged such that the ratio becomes 1:1, the region of the stacked active materials can be effectively formed, so that the above problems can be suppressed.

In the case of forming the active material body in which the number n of layers is 30 or more, the cross-sectional shape of each active material body may not become the zigzag shape inclined along the growth direction but become a columnar shape standing along the normal direction of the substrate 4. Even in this case, it can be confirmed by, for example, cross-sectional scanning electron microscopy that regardless of the cross-sectional shape of the active material body, the growth direction of the active material body extends in the zigzag manner from the bottom surface to upper surface of the active material body.

Moreover, since these active material bodies are arranged on the surface of the substrate 4 at predetermined intervals, the space between adjacent active material bodies can be used as an expansion space in which these active material bodies expand due to charge and discharge. Therefore, the stress of the active material is buffered, and short-circuit between the positive electrode and the negative electrode can be suppressed. As a result, batteries having high charge-discharge cycle characteristic can be obtained.

Next, a method B that is another mode of the operation of the deposition apparatus 100 will be explained.

In the method B, first, the same first traveling step as in the method A is carried out, that is, Steps (a) to (e), (d′), and (e′) are carried out. Next, the second traveling step is carried out without carrying out Step (f) that is the rewinding step in the method A. In the second traveling step, the deposited film forming step and the substrate conveying step in the opposite direction are alternately repeated until the substrate of a predetermined length is unrolled.

More specifically, in the second traveling step, first, only the shutter 12b opens, and the deposited film is further formed in the second deposition possible region 60b on the second layer formed on the surface of the last film formation region (first deposited film forming step in the second traveling step). The last film formation region is, for example, the tenth film formation region in a case where ten film formation regions are formed on the substrate 4 in the first traveling step. The deposited film formed here has the same growth direction as the second layer formed in the second deposition possible region 60b in the first traveling step. Therefore, the second layer increases in thickness in the first deposited film forming step in the second traveling step.

After the third layer is formed by carrying out the deposition with respect to the substrate 4 for a predetermined period of time, the shutter 12b is closed, and the supply of the silicon to the substrate 4 stops. In this closed state, next, the substrate 4 winding around the second roll 8 is unrolled and conveyed to the first roll 3. That is, the substrate 4 is conveyed in the opposite direction. The measuring device 13 adjusts the conveyance distance, so that the conveyance of the substrate stops when a second to last film formation region (ninth film formation region in the above example) reaches the second deposition possible region 60b, and the last film formation region reaches the first deposition possible region 60a.

Next, the shutters 12a and 12b open, and the second deposited film forming step in the second traveling step is carried out. With this, in the second deposition possible region 60b, the second layer in the second to last film formation region increases in thickness. In addition, in the first deposition possible region 60a, the third layer is formed on the thick second layer formed in the last film formation region. Since the third layer formed above is formed in the first deposition possible region 60a as the deposited film, it is the same in the growth direction as the first layer but is different in the growth direction from the second layer.

After such deposited film forming step is carried out for a predetermined period of time, the shutters 12a and 12b are closed, and the supply of the silicon to the substrate 4 stops. In this closed state, the substrate 4 is again conveyed in the opposite direction by the same distance. In the third deposited film forming step, the second layer increases in thickness in a third to last film formation region (eighth film formation region in the above example) in the second deposition possible region 60b, and the third layer is formed in the second to last film formation region in the first deposition possible region 60a.

As above, the deposited film forming step and the substrate conveying step in the opposite direction are alternately repeated until the substrate 4 of the same length as in the first traveling step is unrolled. By the second traveling step, the deposited films each including a three-layer-structure active material body are formed in predetermined regions of the substrate 4 with the deposited film non-forming portion interposed between adjacent deposited films. In the last deposited film forming step of the second traveling step, only the shutter 12a opens, and the deposition is carried out only in the first deposition possible region 60a. In the obtained deposited film, the second layer is twice as thick as the first layer or the third layer.

Next, a step that is the same as the first traveling step is carried out as the third traveling step. With this, the deposited films each including the four-layer-structure active material body are formed with the deposited film non-forming portion interposed between adjacent deposited films. The fourth layer formed above is different in the growth direction from the third layer. Each of the second layer and the third layer is twice as thick as the first layer or the fourth layer.

As above, in the method B, the conveyance direction in the substrate conveying step is set to the forward direction in a (2m−1)-th traveling step, and the conveyance direction in the substrate conveying step is set to the opposite direction in a 2m-th traveling step. Then, by repeating the traveling step n times, the deposited films each including a (n+1)-layer active material body are formed. Here, m is an integer of 1 or more, and n is an integer of 2 or more.

In the deposited film including the plural-layer-structure active material body formed by the method B, a (2x−1)-th formed layer and a 2x-th formed layer are different in the growth direction from each other, but the 2x-th formed layer and a (2x+1)-th formed layer are the same in the growth direction as each other. Here, x is an integer of 1 or more. Since the 2x-th formed layer and the (2x+1)-th formed layer are continuously formed and are the same in the growth direction as each other, they are observed as a single layer in appearance. Therefore, as explained above, in a case where the amount of adherence of the deposited film in each deposited film forming step is constant, each of the second and subsequent layers (except for the last layer) is twice as thick as the first layer or the last layer.

However, in accordance with a method C and a method D that are still another modes of the operation of the deposition apparatus 100, respective layers can be formed to have the same thickness as one another. Each of the method C and the method D is the same as the method B in that: the rewinding step is not carried out; in the (2m−1)-th traveling step, the conveyance direction in the substrate conveying step is set to the forward direction; in the 2m-th traveling step, the conveyance direction in the substrate conveying step is set to the opposite direction; and the traveling step is repeated plural times. Each of the methods C and D will be schematically described below.

In the method C, the first traveling step is carried out in the same manner as in the method B. In the 2m-th traveling step, the shutter 12b is always closed to shield the second deposition possible region 60b, and the deposition is carried out with respect to respective film formation regions only in the first deposition possible region 60a. In contrast, in a (2m+1)-th traveling step, the shutter 12a is always closed to shield the first deposition possible region 60a, and the deposition is carried out with respect to respective film formation regions only in the second deposition possible region 60b. With this, on the layer formed in the previous traveling step, a new layer having a different growth direction can be formed without forming the layer having the same growth direction.

In the method D, in the first traveling step, an open time of the shutter 12a is set to t whereas an open time of the shutter 12b is set to t/2. To be specific, the amount of adherence in the first deposition possible region 60a is set to half the amount of adherence in the second deposition possible region 60b. Further, in the second and subsequent traveling steps, the open time of each of the shutters 12a and 12b is set to t/2, and the amount of adherence in each of the first deposition possible region 60a and the second deposition possible region 60b is set to half. However, the open time of the shutter (12a or 12b) for the last deposition in the last traveling step is set to t. With this, each of the second and subsequent layers (except for the last layer) each formed by one deposited film forming step becomes half in thickness. However, since each of the second and subsequent layers is formed by two deposited film forming steps, each of the second and subsequent layers becomes the same in thickness as the first layer or the last layer.

In accordance with each of the methods C and D, a switching operation of the conveyance direction of the substrate is the same as that in the method B, but respective layers can be formed to have the same thickness as one another by changing the operations of the shutters. Especially, the method D is more preferable since the loss of the deposition material due to the closure of the shutters is small.

The methods A to D can be suitably combined.

The foregoing has explained the operation of the deposition apparatus 100 using as an example the case of forming the active material body made of the silicon oxide. However, the deposition material to be used and the application of the deposited film obtained as above are not limited to the above example. Moreover, in the foregoing, the deposition material (silicon atoms) evaporated by the evaporation source 9 and the gas (oxygen gas) supplied from the nozzle portion 22 react with each other to form the deposited film. However, only the deposition material may be caused to grow on the surface of the substrate 4 without supplying the gas.

### Embodiment 2

### Embodiment of One Surface in W

Hereinafter, the deposition apparatus of Embodiment 2 of the present invention will be explained in reference to the drawings. In the present embodiment, two passages, each of which is the V-shaped substrate passage (V-shaped passage) explained in Embodiment 1, are provided in the chamber, and four deposition possible regions are formed in total.

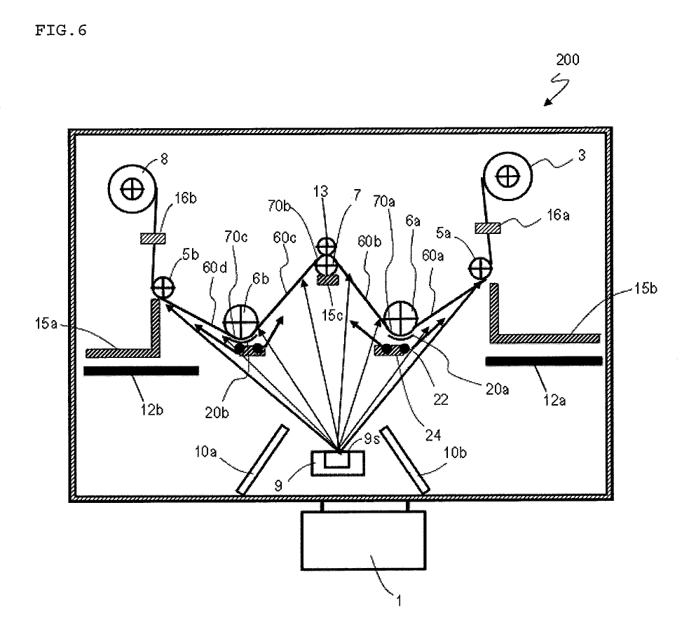

FIG. 6 is a cross-sectional view schematically showing the deposition apparatus of Embodiment 2 of the present invention. For simplicity, the reference numbers are used for the same components as in the deposition apparatus 100 shown in FIG. 1, and explanations thereof are omitted. A deposition apparatus 200 shown in FIG. 6 includes a conveying portion. The conveying portion includes first and second rolls 3 and 8, feed rollers 5a and 5b, first and second guide members (feed rollers) 6a and 6b, and a supporting member (feed roller) 7, which define the conveyance passage of the substrate 4. Moreover, shielding plates 15a to 15c and first and second shielding members 20a and 20b are arranged such that the deposition material evaporated from the evaporation surface 9s is prevented from being incident on the substrate 4 from the normal direction of the substrate 4.

The feed rollers 5a, 6a, 7, 6b, and 5b are arranged in this order from the first roll side on the conveyance passage of the substrate 4. In the present embodiment, the first guide member 6a is provided lower than the adjacent feed roller 5a and supporting member 7. The first guide member 6a guides the substrate 4 such that a surface of the substrate 4 which surface is subjected to the deposition material is convex with respect to the evaporation source 9. Thus, the first guide member 6a forms the V-shaped passage. The first shielding member 20a is provided between the first guide member 6a and the evaporation source 9. With this, the deposition material evaporated from the evaporation surface 9s of the evaporation source 9 is prevented from being incident from the normal direction of the substrate 4, and the deposition possible region on the V-shaped passage is divided into two regions by a first deposition impossible region 70a. With this configuration, the first deposition possible region 60a and the second deposition possible region 60b are formed. The first deposition possible region 60a is located on the first roll side of the first guide member 6a on the V-shaped passage, and the second deposition possible region 60b is located on the second roll side of the first guide member 6a on the V-shaped passage.

The supporting member 7 is provided higher than the adjacent first guide members 6a and 6b. The supporting member 7 supports the substrate 4 from below such that the surface of the substrate 4 which surface is subjected to the deposition material is concave with respect to the evaporation source 9 (to be specific, the surface of the substrate is concave so as to be located away from the evaporation source 9). Thus, the supporting member 7 forms an inverted V-shaped passage. The third shielding plate 15c is provided between the supporting member 7 and the evaporation source 9. With this, the deposition material evaporated from the evaporation surface 9s of the evaporation source 9 is prevented from being incident from the normal direction of the substrate 4, and the deposition possible region on the inverted V-shaped passage is divided into two regions by a second deposition impossible region 70b. With this configuration, the second deposition possible region 60b and a third deposition possible region 60c are formed. The second deposition possible region 60b is located on the first roll side of the supporting member 7 on the inverted V-shaped passage, and the third deposition possible region 60c is located on the second roll side of the supporting member 7 on the inverted V-shaped passage.

The second guide member 6b is provided lower than the adjacent supporting member 7 and feed roller 5b. The second guide member 6b guides the substrate 4 such that the surface of the substrate 4 which surface is exposed to the deposition material is convex with respect to the evaporation source 9. Thus, the second guide member 6b forms the V-shaped passage. The second shielding member 20b is provided between the second guide member 6b and the evaporation source 9. With this, the deposition material evaporated from the evaporation surface 9s of the evaporation source 9 is prevented from being incident from the normal direction of the substrate 4, and the deposition possible region on the V-shaped passage is divided into two regions by a third deposition impossible region 70c. With this configuration, the third deposition possible region 60c and a fourth deposition possible region 60d are formed. The third deposition possible region 60c is located on the first roll side of the second guide member 6b on the V-shaped passage, and the fourth deposition possible region 60d is located on the second roll side of the second guide member 6b on the V-shaped passage.

The incident direction of the deposition material on each of the deposition possible regions 60a to 60d is controlled so as to be inclined by an angle of not smaller than 45° and not larger than 75° with respect to the normal direction of the substrate 4. As in the present embodiment, in a case where the surface of the substrate 4 which surface is exposed to the deposition material is conveyed in a W shape formed by connecting two V-shaped passages, this conveyance passage may be called a “W-shaped passage”.

The shutter 12a can be moved such that the evaporated deposition material is prevented from reaching one or both of the first and second deposition possible regions 60a and 60b or is allowed to reach one or both of the first and second deposition possible regions 60a and 60b. The shutter 12b can be moved such that the evaporated deposition material is prevented from reaching one or both of the third and fourth deposition possible regions 60c and 60d or is allowed to reach one or both of the third and fourth deposition possible regions 60c and 60d.

The deposition apparatus 200 includes the heater portions 16a and 16b configured to heat the substrate 4 to 200 to 400° C. The heater portions 16a and 16b are respectively provided on the first roll side of the first deposition possible region 60a and on the second roll side of the fourth deposition possible region 60d.

An operation method of the deposition apparatus 200 is basically the same as the above-described method regarding the operation of the deposition apparatus 100, but differences therebetween will be explained below.

First, the method A will be explained.

In the first deposited film forming step, the shutters 12a and 12b are located such that the deposition is not carried out with respect to the second to fourth deposition possible regions 60b to 60d, and the shutter 12a opens for the first deposition possible region 60a. With this, the first layer is formed in the first deposition possible region 60a. After the shutter 12a is closed, the substrate 4 is unrolled in the forward direction. Then, the substrate 4 stops when the portion subjected to the deposition in the first deposition possible region 60a has reached the second deposition possible region 60b.

Next, in the second deposited film forming step, the shutter 12b shields the third and fourth deposition possible regions 60c and 60d, and the shutter 12a opens for the first and second deposition possible regions 60a and 60b. With this, the second layer is formed in the second deposition possible region 60b, and the first layer is formed in the first deposition possible region 60a.

The substrate is further conveyed in the forward direction. Then, in the third deposited film forming step, the shutter 12b is located such that the deposition is not carried out with respect to the fourth deposition possible region 60d, and the shutters 12a and 12b open for the first to third deposition possible regions 60a to 60c. With this, the third layer is formed in the third deposition possible region 60c, the second layer is formed in the second deposition possible region 60b, and the first layer is formed in the first deposition possible region 60a.

The substrate is further conveyed in the forward direction. Then, in the fourth deposited film forming step, the shutters 12a and 12b fully open, and the deposition is carried out with respect to all the deposition possible regions 60a to 60d. With this, the fourth layer is formed in the fourth deposition possible region 60d, the third layer is formed in the third deposition possible region 60c, the second layer is formed in the second deposition possible region 60b, and the first layer is formed in the first deposition possible region 60a. In the fifth and subsequent deposited film forming steps, the fourth deposited film forming step is repeated. As above, by carrying out the traveling step once, the deposited films (deposited films each having the structure shown in FIG. 4) each including the four-layer-structure active material body can be formed in predetermined regions of the sheet-shaped substrate 4.

However, as with Embodiment 1, the shutters 12a and 12b may fully open in all the deposited film forming steps, and the deposition may be carried out with respect to all the first to fourth deposition possible regions 60a to 60d.

By further carrying out the above Steps (f) to (i), the deposited films each including the active material body having an arbitrary number n of layers (for example, n=30 to 40) can be formed in predetermined regions of the substrate 4. Here, the number n of layers is four times the number of times of the traveling step.

In Embodiment 2, the sum of the length of the first deposition possible region 60a and the length of the first deposition impossible region 70a, the sum of the length of the second deposition possible region 60b and the length of the second deposition impossible region 70b, and the sum of the length of the third deposition possible region 60c and the length of the third deposition impossible region 70c become 1:1:1. To be specific, the sum of one deposition possible region and its adjacent deposition impossible region is substantially the same as the other sum. Further, it is preferable that a ratio of the lengths of the first, second, third, and fourth deposition possible regions 60a, 60b, 60c, and 60d be 1:1:1:1. As above, in a case where the lengths of the first, second, third, and fourth deposition possible regions 60a, 60b, 60c, and 60d through which the substrate 4 sequentially passes are set to 1:1:1:1, the lengths of respective portions constituting the zigzag active material body can be substantially uniformized, and the region of the stacked active materials can be effectively formed. In a case where the above ratio becomes far from 1:1:1:1, problems occur, that is, the region of the stacked active materials decrease, and the charging capacity per unit area decreases.

Next, the method B in Embodiment 2 will be explained.

In the method B, the first traveling step is the same as that in the method A. In the first deposited film forming step in the second traveling step, the first to third deposition possible regions are shielded by the shutters, and the deposited film is further formed in the fourth deposition possible region 60d on the fourth layer formed on the surface of the last film formation region. The deposited film formed here has the same growth direction as the fourth layer formed in the fourth deposition possible region 60d in the first traveling step. Therefore, the fourth layer increases in thickness in the first deposited film forming step in the second traveling step. Next, the shutters are closed, and the substrate conveying step in the opposite direction is carried out. The conveyance of the substrate stops when the second to last film formation region has reached the fourth deposition possible region 60d, and the last film formation region has reached the third deposition possible region 60c.

Next, in the second deposited film forming step, the fourth layer of the second to last film formation region increases in thickness in the fourth deposition possible region 60d, and a fifth layer is formed in the third deposition possible region 60c on the thick fourth layer formed on the last film formation region. Since the fifth layer formed here is formed in the third deposition possible region 60c as the deposited film, it is the same in the growth direction as the third layer but is different in the growth direction from the fourth layer.

The substrate conveying step in the opposite direction is further carried out. Then, in the third deposited film forming step, the fourth layer of the third to last film formation region increases in thickness in the fourth deposition possible region 60d, the fifth layer is formed on the second to last film formation region in the third deposition possible region 60c, and a sixth layer is formed on the last film formation region in the second deposition possible region 60b. The sixth layer formed here is the same in the growth direction as the second layer but is different in the growth direction from the fifth layer.

Again, the substrate conveying step in the opposite direction is carried out. Then, in the fourth deposited film forming step, the fourth layer of a fourth to last film formation region is increased in thickness in the fourth deposition possible region 60d, the fifth layer is formed on the third to last film formation region in the third deposition possible region 60c, the sixth layer is formed on the second to last film formation region in the second deposition possible region 60b, and a seventh layer is formed on the last film formation region in the first deposition possible region 60a. The seventh layer formed here is the same in the growth direction as the first layer but is different in the growth direction from the sixth layer.

As above, the deposited film forming step and the substrate conveying step in the opposite direction are alternately repeated until the substrate 4 of the same length as in the first traveling step is unrolled. By the second traveling step, the deposited films each including a seven-layer-structure active material body are formed in predetermined regions of the substrate 4 with the deposited film non-forming portion interposed between adjacent deposited films. In the deposited film formed as above, the fourth layer is twice as thick as the other layer.

Next, a step that is the same as the first traveling step is carried out as the third traveling step. With this, the deposited films each including a ten-layer-structure active material body are formed with the deposited film non-forming portion interposed between adjacent deposited films. In this deposited film, each of the fourth and seventh layers is twice as thick as the other layer.

In the deposited film including the plural-layer-structure active material body formed by the method B using the deposition apparatus 200, a (4y−3)-th formed layer and a (4y−2)-th formed layer are different in the growth direction from each other, the (4y−2)-th formed layer and a (4y−1)-th formed layer are different in the growth direction from each other, and the (4y−1)-th formed layer and a 4y-th formed layer are different in the growth direction from each other, but the 4y-th formed layer and a (4y+1)-th formed layer are the same in the growth direction as each other. Further, the (4y−1)-th formed layer and a (4y+2)-th formed layer are the same in the growth direction as each other, the (4y−2)-th formed layer and a (4y+3)-th formed layer are the same in the growth direction as each other, and the (4y−3)-th formed layer and a (4y+4)-th formed layer are the same in the growth direction as each other. Here, y is an integer of 1 or more.

Since the 4y-th formed layer and the (4y+1)-th formed layer are continuously formed and are the same in the growth direction as each other, these two layers formed by two different steps are observed as a single layer in appearance. To be specific, the fourth formed layer and the fifth formed layer are regarded as the fourth layer, the eighth formed layer and the ninth formed layer are regarded as the seventh layer, and the twelfth formed layer and the thirteenth formed layer are regarded as the tenth layer. In this case, in a case where the amount of adherence of the deposited film in each deposited film forming step is constant, each of (3z+1)-th layers, such as the fourth layer, the seventh layer, and the tenth layer, is twice as thick as a 3z-th layer or a (3z−1)-th layer. Here, z is an integer of 1 or more. Such layer configuration is shown in FIG. 13. FIG. 13 is a schematic diagram showing a cross section of the plural-layer-structure active material body formed on the projection 72.

Further, respective layers can be formed to have the same thickness as one another by each of the methods C and D.

In the method C, the first traveling step is carried out in the same manner as in the method B. In a 2m-th traveling step, the fourth deposition possible region 60d is always shielded by the shutter, and the deposition is carried out only in the other deposition possible regions. In the (2m+1)-th traveling step, the first deposition possible region 60a is always shielded by the shutter, and the deposition is carried out only in the other deposition possible regions.

In the method D, in the first traveling step, a deposition time in each of the first deposition possible region 60a, the second deposition possible region 60b, and the third deposition possible region 60c is set to t whereas the deposition time in the fourth deposition possible region 60d is set to t/2. Further, in the second and subsequent traveling steps, the deposition time in each of the second deposition possible region 60b and the third deposition possible region 60c is set to t whereas the deposition time in each of the first deposition possible region 60a and the fourth deposition possible region 60d is set to t/2. The deposition time in the last deposition possible region (60a or 60d) in the last traveling step is set to t.

In accordance with the deposition apparatus 200 of the present embodiment, since four deposition possible regions are formed, the deposition material emitted at wider angles can be utilized for the deposition. Thus, the utilization ratio of the deposition material can be further increased.

### Embodiment 3

Embodiment of W1 (Both Surfaces)

Hereinafter, the deposition apparatus of Embodiment 3 of the present invention will be explained in reference to the drawings. As with Embodiment 2, the present embodiment includes the W-shaped substrate passage (W-shaped passage) and four deposition possible regions (first to fourth deposition possible regions) 60a to 60d. However, the present embodiment is different from Embodiment 2 in that the conveying portion in the present embodiment is configured to turn over the substrate 4 having passed through the first and second deposition possible regions 60a and 60b and guide the substrate 4 to the third and fourth deposition possible regions 60c and 60d.

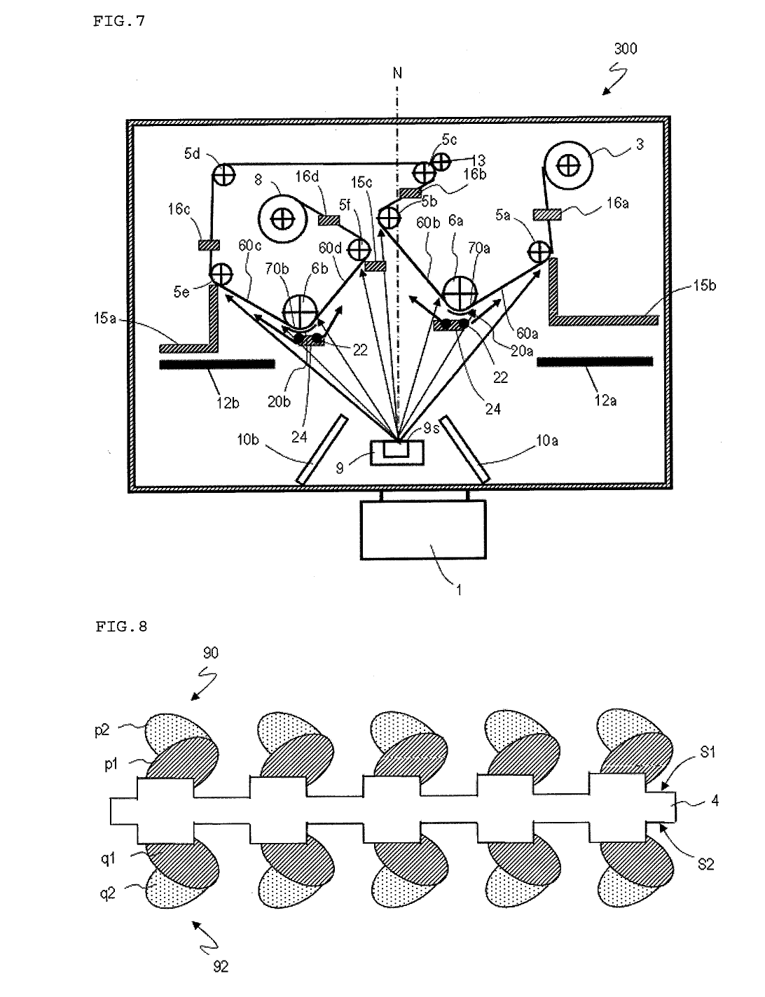

FIG. 7 is a cross-sectional view showing the deposition apparatus of the present embodiment. For simplicity, the same reference numbers are used for the same components as in the deposition apparatus 200 shown in FIG. 6, and explanations thereof are omitted.

In a deposition apparatus 300, the conveyance passage of the substrate 4 is defined by first and second rolls 3 and 8, feed rollers 5a to 5f, and first and second guide members 6a and 6b. The feed rollers 5c to 5e are provided between the second deposition possible region 60b and the third deposition possible region 60c on the conveyance passage of the substrate 4 so as to be located around the second roll 8 (inverted structure). With this configuration, a surface of the substrate 4 which surface faces the evaporation source 9s can be inverted. Therefore, when the substrate 4 passes through the first and second deposition possible regions 60a and 60b, the deposition can be carried out with respect to one surface (referred to as a “first surface”) of the substrate 4. When the substrate 4 passes through the third and fourth deposition possible regions 60c and 60d, the deposition can be carried out with respect to the other surface (referred to as a “second surface”) of the substrate 4. Therefore, in accordance with the deposition apparatus 300, the deposited films can be continuously formed on both surfaces of the substrate 4 while maintaining the vacuum state in the chamber 2. It is preferable that the position of the film formation region on the first surface and the position of the film formation region on the second surface coincide with each other. Therefore, it is preferable that the conveyance distance from the feed roller 5b to the feed roller 5e be set to an integral multiple of the sum of the length of the deposition possible region and the length of the deposition impossible region in the longitudinal direction of the substrate 4 (or the sum of the length of the film formation region 30a and the length of the deposited film non-forming portion 31a shown in FIG. 11). Moreover, in the present embodiment, the second deposition possible region 60b and the fourth deposition possible region 60d are formed to face each other, and the shielding plate 15c is provided between the deposition possible regions 60b and 60d so as to cover the feed rollers 5b and 5f. The shielding plate 15c prevents the deposition material from being incident on the feed rollers 5b and 5f and controls the incidence angle at an upper end portion of each of the deposition possible regions 60b and 60d.

In the present embodiment, in the cross section perpendicular to the surface of the substrate 4 and including the conveyance direction of the substrate 4, the first guide member 6a and the second guide member 6b are respectively provided on both sides of a normal line N extending through the center of the evaporation surface 9s. Moreover, the conveying portion is provided with respect to the evaporation source 9 such that any one of the first to fourth deposition possible regions 60a to 60d (deposition possible region 60b in the example shown in the drawing) intersects with the normal line N extending through the center of the evaporation surface 9s. This is advantageous since the deposition can be carried out by maximally utilizing the region where the concentration of the deposition material is high, among the deposition possible regions.

Moreover, heater portions 16a to 16d configured to heat the substrate 4 to, for example, 200 to 400° C. are respectively provided in the vicinities of upper ends of the deposition possible regions 60a to 60d. That the heater portions 16a to 16d “are respectively provided in the vicinities of upper ends of the deposition possible regions 60a to 60d” denotes that each heater portion is provided in the region other than the corresponding deposition possible region and is provided at a position so as to heat the substrate 4 immediately before the substrate 4 is introduced to the corresponding deposition possible region. With this configuration, in the case of conveying the substrate 4 from the first roll 3 to the second roll 8, the substrate 4 can be heated by the heater portion 16a or 16c before the substrate 4 passes through each V-shaped passage. In the case of conveying the substrate 4 in the opposite direction, the substrate 4 can be heated by the heater portion 16d or 16b before the substrate 4 is introduced to each V-shaped passage.

The operation method of the deposition apparatus 300 is basically the same as the operation method of the deposition apparatus 200. However, the operations of the shutters 12a and 12b are suitably modified on the ground that: three-dimensional positions of the third and fourth deposition possible regions 60c and 60d are opposite to those in the deposition apparatus 200; and the deposition is not carried out with respect to the substrate 4 located between the feed rollers 5b and 5e.

The method A will be specifically explained. In a state where the third and fourth deposition possible regions 60c and 60d are shielded by the shutter 12b, the first layer of the first surface is formed in the first deposition possible region 60a in the first deposited film forming step by utilizing the movement of the shutter 12a. In the second deposited film forming step, the second layer of the first surface is formed in the second deposition possible region 60b, and the first layer of the first surface is formed in the first deposition possible region 60a. The substrate 4 is unrolled while further repeating the second deposited film forming step. When a rear surface (second surface) of the region on which the film is formed in the first deposited film forming step has reached the third deposition possible region 60c, the shutter 12b opens for the third deposition possible region 60c, and the deposited film is formed. With this, the first layer of the second surface is formed in the third deposition possible region 60c at the same time as the formation of the deposited film in each of the first and second deposition possible regions 60a and 60b. In the next deposited film forming step, the shutter 12b opens for the third and fourth deposition possible regions 60c and 60d, the first layer of the second surface is formed in the third deposition possible region 60c, and the second layer of the second surface is formed in the fourth deposition possible region 60d. Simultaneously, the formation of the deposited film is carried out in each of the first and second deposition possible regions 60a and 60b. With this, by carrying out the traveling step once, the deposited films each including the two-layer-structure active material body can be formed on both surfaces of the substrate 4.

Moreover, the shutters 12a and 12b may fully open in all the deposited film forming steps, and the deposition may be carried out with respect to all the first to fourth deposition possible regions 60a to 60d.

FIG. 8 is a cross-sectional view showing one example of the deposited film formed on each of both surfaces of the substrate 4 using the deposition apparatus 300. The deposited film shown is manufactured by carrying out the traveling step once in accordance with the above-described method.

In the present embodiment, it is preferable that the ratio of the lengths of the first, second, third, and fourth deposition possible regions 60a, 60b, 60c, and 60d be 1:1:1:1. With this, since the lengths of the deposition possible regions can be uniformized, the region of the stacked active material can be effectively utilized. Moreover, since the position of the film formation region is the same between the first surface and the second surface, this is convenient when cutting the substrate 4 to obtain electrodes each having a predetermined size. Moreover, active material bodies 90 and 92 having the same film formation area as each other can be respectively formed on both surfaces of the substrate 4. In the case of manufacturing a lithium-ion secondary battery electrode using such substrate 4, a stress applied to a first surface S1 of the substrate 4 by the expansion of the active material body 90 and a stress applied to a second surface S2 of the substrate 4 by the expansion of the active material body 92 become substantially the same as each other. Therefore, it is possible to effectively prevent the substrate 4 from being bent by the difference between these stresses when charge and discharge are repeated.

In the present embodiment, used as the substrate 4 is a metal foil having surfaces (first surface and second surface) S1 and S2 on each of which the concave-convex pattern is formed. The pattern formed on each of the surfaces S1 and S2 is the same as the concave-convex pattern explained in Embodiment 1, so that an explanation thereof is omitted.

A plurality of the active material bodies 90 stand on the first surface S1 of the substrate 4, each active material body 90 including two layers which are different in the growth direction from each other. The active material body 90 is constituted by the first portion p1 formed in the first deposition possible region 60a and the second portion p2 formed on the first portion p1 in the second deposition possible region 60b. Moreover, the active material body 92 having the same two-layer structure as above is formed on the second surface S2 of the substrate 4. The active material body 92 is constituted by a first portion q1 formed in the third deposition possible region 60c and a second portion q2 formed in the fourth deposition possible region 60d.

In the present embodiment, it is preferable that the conveying portion and the shielding portion be provided such that the ranges of the incidence angles θ of the deposition materials in the first to fourth deposition possible regions 60a to 60d are substantially the same as one another.

The methods B to D in Embodiment 3 may be suitably modified in accordance with the methods B to D in Embodiments 1 and 2.

### Embodiment 4

### Embodiment of W2 (Both Surfaces)

Hereinafter, the deposition apparatus of Embodiment 4 of the present invention will be explained in reference to the drawings. The conveying portion of the deposition apparatus of the present embodiment is configured to include: two passages each of which is the W-shaped substrate passage (W-shaped passage) explained in Embodiment 2 in reference to FIG. 6; and the inverted structure configured to turn over the surface of the substrate 4 between these W-shaped passages, the surface being subjected to the deposition material. The inverted structure may be the same as the structure explained in Embodiment 3 in reference to FIG. 7.

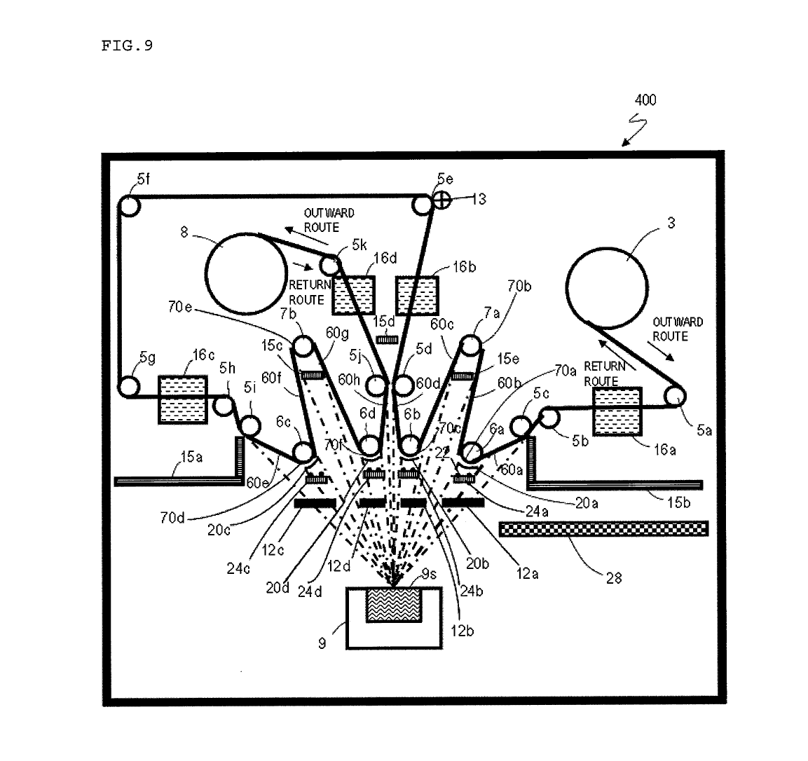

FIG. 9 is a cross-sectional view schematically showing the deposition apparatus of the present embodiment. For simplicity, the same reference numbers are used for the same components as in the deposition apparatuses 100, 200, and 300 explained in the above embodiments, and explanations thereof are omitted.

A deposition apparatus 400 shown in FIG. 9 includes the conveying portion and shutters 12a to 12d. The conveying portion includes first and second rolls 3 and 8, feed rollers 5a to 5k, first to fourth guide members 6a to 6d, and first and second supporting members 7a and 7b. With this, the conveyance passage of the substrate 4 is defined. Moreover, shielding plates 15a to 15e and first to fourth shielding members 20a to 20d are provided such that the deposition material evaporated from the evaporation surface 9s is not incident on the substrate 4 from the normal direction of the substrate 4.

The feed rollers 5a to 5k are provided in this order from the first roll side on the conveyance passage of the substrate 4. Moreover, the first to fourth guide members (feed rollers) 6a to 6d are provided in this order from the first roll side on the conveyance passage of the substrate 4. Further, the first and second supporting members 7a and 7b are provided in this order from the first roll side on the conveyance passage of the substrate 4. As with the above-described embodiments, the guide members 6a to 6d guide the substrate 4 such that the surface of the substrate 4 which surface is exposed to the deposition material is convex with respect to the evaporation source 9. Thus, each of the guide members 6a to 6d forms the V-shaped passage. The first to fourth shielding members 20a to 20d are respectively provided between the guide member 6a and the evaporation source 9, the guide member 6b and the evaporation source 9, the guide member 6c and the evaporation source 9, and the guide member 6d and the evaporation source 9. With this, the deposition material evaporated from the evaporation surface 9s of the evaporation source 9 is prevented from being incident from the normal direction of the substrate 4, and the deposition possible region on the V-shaped passage is divided into two regions by each of the deposition impossible regions 70a, 70c, 70d, and 70f. With this configuration, the first deposition possible region 60a located on the first roll side of the first guide member 6a and the second deposition possible region 60b located on the second roll side of the first guide member 6a are formed on the V-shaped passage formed by the first guide member 6a. Similarly, the third deposition possible region 60c located on the first roll side of the second guide member 6b and the fourth deposition possible region 60d located on the second roll side of the second guide member 6b are formed on the V-shaped passage formed by the second guide member 6b. A fifth deposition possible region 60e located on the first roll side of the third guide member 6c and a sixth deposition possible region 60f located on the second roll side of the third guide member 6c are formed on the V-shaped passage formed by the third guide member 6c. A seventh deposition possible region 60g located on the first roll side of the fourth guide member 6d and an eighth deposition possible region 60h located on the second roll side of the fourth guide member 6d are formed on the V-shaped passage formed by the fourth guide member 6d.

Moreover, each of the supporting members 7a and 7b supports the substrate 4 from below such that the surface of the substrate 4 which surface is exposed to the deposition material is concave with respect to the evaporation source 9. Thus, each of the supporting members 7a and 7b forms the inverted V-shaped passage. The shielding member 15e is provided between the supporting member 7a and the evaporation source 9, and the shielding member 15c is provided between the supporting member 7b and the evaporation source 9. With this, the deposition material evaporated from the evaporation surface 9s of the evaporation source 9 is prevented from being incident from the normal direction of the substrate 4, and the deposition possible region on the inverted V-shaped passage is divided into two regions by each of the deposition impossible regions 70b and 70e. With this configuration, the second deposition possible region 60b located on the first roll side of the first supporting member 7a and the third deposition possible region 60c located on the second roll side of the first supporting member 7a are formed on the inverted V-shaped passage formed by the first supporting member 7a. Similarly, the sixth deposition possible region 60f located on the first roll side of the second supporting member 7b and the seventh deposition possible region 60g located on the second roll side of the second supporting member 7b are formed on the inverted V-shaped passage formed by the second supporting member 7b.

The shutters 12a to 12d and a shutter 28 capable of shielding all the deposition possible regions are provided between a group of the first to eighth deposition possible regions 60a to 60h and the evaporation surface 9s.

The conveying portion and the shielding portion in the present embodiment are provided with respect to the evaporation source 9 such that the incident direction of the deposition material on each of the first to eighth deposition possible regions 60a to 60h is inclined by an angle of, for example, not smaller than 45° and not larger than 75° with respect to the normal direction of the substrate 4.

The feed rollers 5e to 5g in the present embodiment are provided between the fourth deposition possible region 60d and the fifth deposition possible region 60e on the conveyance passage of the substrate 4 so as to be located around the second roll 8 (inverted structure). With this configuration, the substrate 4 having passed through the W-shaped passage including the first to fourth deposition possible regions 60a to 60d can be turned over to be guided to the fifth to eighth deposition possible regions 60e to 60h. Therefore, the deposited films can be continuously formed on both surfaces of the substrate 4 while maintaining the vacuum state in the chamber 2.

The deposition apparatus 400 further includes four heater portions 16a to 16d which are respectively provided in regions other than the deposition possible regions and heat the substrate 4 to 200 to 400° C. The heater portions 16a to 16d are respectively provided in the vicinities of upper ends of the first, fourth, fifth, and eighth deposition possible regions 60a, 60d, 60e, and 60h. With this configuration, in the case of conveying the substrate 4 from the first roll 3 to the second roll 8, the substrate 4 can be heated by the heater portion 16a or 16c immediately before the substrate 4 passes through each W-shaped passage. In the case of conveying the substrate 4 in the opposite direction, the substrate 4 can be heated by the heater portion 16b or 16d before the substrate 4 passes through each W-shaped passage.

In the present embodiment, it is preferable that the conveying portion be provided with respect to the evaporation source 9 such that in the cross section perpendicular to the surface of the substrate 4 and including the conveyance direction of the substrate 4, a group of the first and second guide members 6a and 6b and a group of the third and fourth guide members 6c and 6d are respectively provided on both sides of the normal line N extending through the center of the evaporation source 9, and any one of the first to eighth deposition possible regions 60a to 60h intersects with the normal line extending through the center of the evaporation source 9. With this, since the deposition can be carried out by utilizing the region where the concentration of the deposition material evaporated from the evaporation source 9 is high, among the deposition possible regions, the use efficiency of the deposition material can be improved.

The operation method of the deposition apparatus 400 may be suitably modified in accordance with the operation method of the deposition apparatus 200 and the operation method of the deposition apparatus 300. When closing the shutter in the substrate conveying step 504, all the deposition possible regions may be shielded by utilizing the shutter 28.

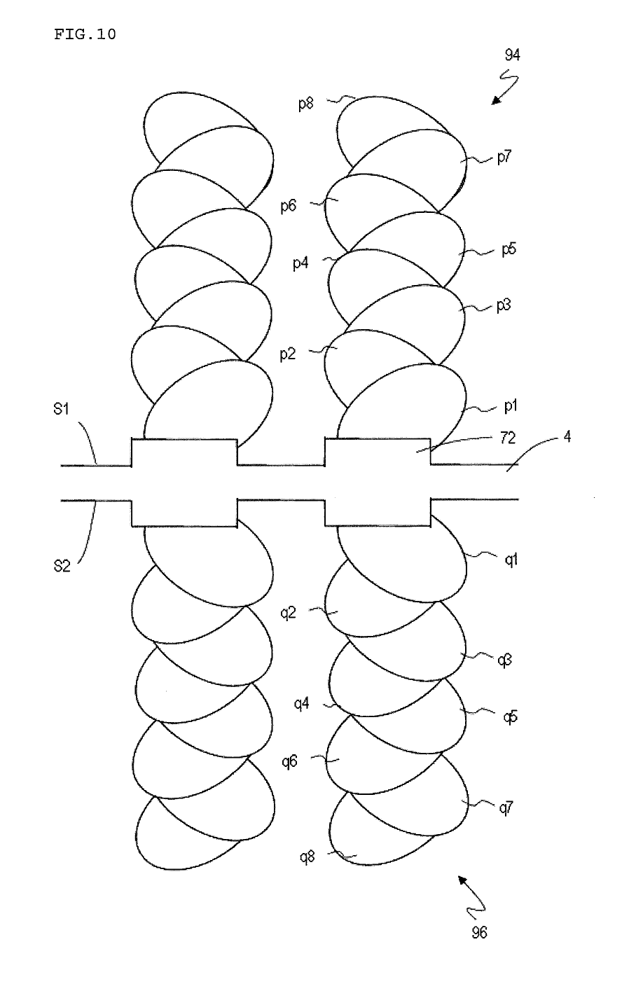

FIG. 10 is a cross-sectional view showing one example of the configuration of the deposited film formed on each of both surfaces of the substrate 4 using the deposition apparatus 400. The deposited film shown is manufactured by carrying out the traveling step twice in accordance with the method regarding the deposition apparatus 200 and the method regarding the deposition apparatus 300. To be specific, by carrying out the first traveling step, the deposited films each including the four-layer-structure active material body can be formed on each of both surfaces of the substrate 4. Moreover, by carrying out the second traveling step, as shown in FIG. 10, the deposited films each including the eight-layer-structure active material body can be formed on each of both surfaces of the substrate 4.

In the present embodiment, a metal foil having surfaces (first surface and second surface) S1 and S2 on each of which the concave-convex pattern is formed can be used as the substrate 4. Herein, the pattern formed on each of the surfaces S1 and S2 is the same as the concave-convex pattern explained in Embodiment 1, so that an explanation thereof is omitted.

A plurality of active material bodies 94 each including eight layers which are alternately different in the growth direction from each other stand on the first surface S1 of the substrate 4, and a plurality of active material bodies 96 each including eight layers which are alternately different in the growth direction from each other stand on the second surface S2 of the substrate 4. Each active material body 94 has a structure (the number n of layers=8) in which the first to eighth portions p1 to p8 whose growth directions are inclined alternately oppositely with respect to the normal direction of the first surface S1. Moreover, the active material bodies 96 each having the same eight-layer structure are formed on the second surface S2.

In the present embodiment, the sum of the length of the first deposition possible region 60a and the length of the first deposition impossible region 70a, the sum of the length of the second deposition possible region 60b and the length of the second deposition impossible region 70b, the sum of the length of the third deposition possible region 60c and the length of the third deposition impossible region 70c, the sum of the length of the fifth deposition possible region 60e and the length of the fourth deposition impossible region 70d, the sum of the length of the sixth deposition possible region 60f and the length of the fifth deposition impossible region 70e, and the sum of the length of the seventh deposition possible region 60g and the length of the sixth deposition impossible region 70f become 1:1:1. To be specific, the sum of one deposition possible region and its adjacent deposition impossible region is substantially the same as the other sum. Further, due to the same reason as above, it is preferable that the conveying portion and the shielding portion be configured such that the ratio of the lengths of the first to eighth deposition possible regions 60a to 60h become 1:1:1:1:1:1:1:1.

The methods B to D in Embodiment 4 are suitably modified in accordance with the methods B to D in Embodiments 1 to 3.

Although the deposition apparatus 400 includes the inverted structure configured to turn over the substrate 4, the deposition apparatus of the present embodiment does not have to include the inverted structure. In such deposition apparatus, by carrying out the traveling step once in which the substrate 4 passes through two W-shaped passages, the eight-layer-structure (the number n of layers=8) active material bodies are formed only on one surface of the substrate 4.

The shape of the active material body formed by the deposition apparatus of the present invention is not limited to the above shapes explained in the above various embodiments and can be suitably selected depending on a design capacity of a battery to which the present invention is applied. For example, the number n of layers of each active material body is also suitably selected. It is preferable that the number n of layers be three or more. In a case where the number n of layers is two or less, the expansion of the active material body in the width direction (horizontal direction) may not be adequately suppressed. An upper limit of a preferable range of the number n of layers is determined depending on the entire thickness (for example, 100 μm or less) of the active material body and the thickness (for example, 2 μm or more) of each portion constituting the active material body. For example, the upper limit is 50 (100 μm/2 μm). More preferably, the number n of layers is not less than 30 and not more than 40.

As described above, in accordance with the deposition apparatus of the embodiments of the present invention, the active material layer including a plurality of active material bodies provided at intervals can be formed on the surface of the substrate 4. The substrate 4 on which the active material layer is formed is cut into pieces each having a predetermined size according to need, and each piece is used as an negative electrode for a nonaqueous electrolyte secondary battery, such as the lithium-ion secondary battery. In accordance with the negative electrode obtained as above, the breakdown of the active material body and the deformation of a polar plate due to the expansion of the active material are suppressed, and the deformation of holes of separators is also prevented. Therefore, high charge-discharge cycle characteristic can be realized.

The above negative electrode is applicable to the nonaqueous electrolyte secondary batteries of various shapes, such as a cylindrical shape, a flat shape, a coin shape, and a square shape. The nonaqueous electrolyte secondary battery can be manufactured by a known method. Specifically, a polar plate group is formed such that the negative electrode obtained using the deposition apparatus of the present invention is caused to face a positive plate containing a positive electrode active material with a separator, such as a microporous film, interposed therebetween. By storing the polar plate group and the electrolytic solution having the lithium ion conductivity in a case, the nonaqueous electrolyte secondary battery is obtained. As the positive electrode active material and the electrolytic solution, materials generally used for the lithium ion secondary battery can be used. For example, LiCoO₂, LiNiO₂, LiMn₂O₄, or the like is used as the positive electrode active material, and an electrolytic solution obtained by dissolving lithium hexafluorophosphate or the like in cyclic carbonates, such as ethylene carbonate and propylene carbonate, can be used as the electrolytic solution. Moreover, a sealing configuration of the battery is not especially limited.

### INDUSTRIAL APPLICABILITY

The deposition apparatus of the present invention may be used to manufacture various devices utilizing the deposited film, for example, to manufacture electrochemical devices, such as batteries, optical devices, such as photonic devices and optical circuit parts, and various device elements, such as sensors. The present invention is applicable to electrochemical elements at large. However, the present invention is advantageous in that by especially applying the present invention to manufacture of a battery polar plate using the active material which significantly expands and shrinks due to charge and discharge, it is possible to provide a polar plate capable of suppressing the deformation of the polar plate and the generation of wrinkles due to the expansion of the active material and having high energy density.

1. A roll-to-roll type deposited film forming method for forming a deposited film on a sheet-shaped substrate such that the substrate winds around a first roll and a second roll so as to be conveyable in a chamber, and a deposition material is evaporated from an evaporation source,
the method comprising the steps of:
(a) holding the substrate such that: between the first roll and the second roll on a conveyance passage of the substrate, a first surface that is a surface of the substrate which surface is exposed to the evaporated deposition material is convex with respect to the evaporation source by a first guide member provided in a deposition possible region to which the evaporated deposition material reaches; a first deposition possible region is formed, which is located on the first roll side of the first guide member on the conveyance passage of the substrate; and a second deposition possible region is formed, which is not continuous with the first deposition possible region and is located on the second roll side of the first guide member;
(b) heating the evaporation source to evaporate the deposition material;
(c) opening a shutter member provided between the evaporation source and the substrate to form a first deposited film on a first film formation region on the first surface in the first deposition possible region;
(d) after Step (c), closing the shutter member to shield the substrate from the evaporated deposition material and conveying the substrate such that the first film formation region is located at the second deposition possible region by unrolling the substrate by the first roll and taking up the substrate by the second roll; and
(e) after Step (d), opening the shutter member, forming the first deposited film on a second film formation region in the first deposition possible region, the second film formation region being located on the first surface and not continuous with the first film formation region, and at the same time, forming a second deposited film in the second deposition possible region on the first deposited film formed on the first film formation region in Step (c), the second deposited film having a different growth direction from the first deposited film.

2. The deposited film forming method according to claim 1, further comprising the steps of:
(d′) after Step (e), closing the shutter member to shield the substrate from the evaporated deposition material and conveying the substrate by a substantially same distance as in Step (d) by unrolling the substrate by the first roll and taking up the substrate by the second roll; and
(e′) after Step (d′), opening the shutter member, forming the first deposited film in the first deposition possible region on a third film formation region which is located on the first surface and not continuous with the second film formation region, and at the same time, forming the second deposited film in the second deposition possible region on the first deposited film formed on the second film formation region in Step (e), the second deposited film having a different growth direction from the first deposited film.

3. The deposited film forming method according to claim 1, wherein the evaporated deposition material is not incident on the substrate from a normal direction of the substrate by a first shielding member located between the first guide member and the evaporation source.

4. The deposited film forming method according to claim 1, wherein a ratio of a length of the first deposition possible region and a length of the second deposition possible region is 1:1.

5. The deposited film forming method according to claim 1, further comprising:
(f) closing the shutter member and rewinding the substrate in a direction opposite to a direction in which the substrate is conveyed in Step (d);
(g) repeating same procedures as in Steps (c) to (e) to form a third deposited film on the second deposited film and form a fourth deposited film on the third deposited film, the third deposited film having a different growth direction from the second deposited film, the fourth deposited film having a different growth direction from the third deposited film;
(h) repeating same procedures as in Steps (f) and (g) to obtain a deposited film including five or more layers whose growth directions are alternately different from each other.

6. The deposited film forming method according to claim 1, wherein the substrate is heated to 200 to 400° C. before holding the substrate in Step (a).

7. The deposited film forming method according to claim 1, wherein in Step (a), the substrate is held such that: between the first roll and the second roll on the conveyance passage of the substrate, the first surface is concave with respect to the evaporation source on the second roll side of the first guide member by a supporting member provided in the deposition possible region; and a third deposition possible region is formed, which is not continuous with the second deposition possible region and is located on the second roll side of the supporting member on the conveyance passage of the substrate,
the method further comprising the steps of:
(i) after Step (e), closing the shutter member to shield the substrate from the evaporated deposition material and conveying the substrate by a substantially same distance as in Step (d) by unrolling the substrate by the first roll and taking up the substrate by the second roll; and
(j) after Step (i), opening the shutter member, forming the first deposited film in the first deposition possible region on a third film formation region which is located on the first surface and is not continuous with the second film formation region, and at the same time, forming the second deposited film in the second deposition possible region on the first deposited film formed on the second film formation region in Step (e), the second deposited film having a different growth direction from the first deposited film, and further forming a third deposited film in the third deposition possible region on the second deposited film formed on the first film formation region in Step (e), the third deposited film having a different growth direction from the second deposited film.

8. The deposited film forming method according to claim 7, wherein in Step (a), the substrate is held such that: between the first roll and the second roll on the conveyance passage of the substrate, the first surface is convex with respect to the evaporation source on the second roll side of the supporting member by a second guide member provided in the deposition possible region; and a fourth deposition possible region is formed, which is not continuous with the third deposition possible region and is located on the second roll side of the second guide member on the conveyance passage of the substrate,
the method further comprising the steps of:
(k) after Step (j), closing the shutter member to shield the substrate from the evaporated deposition material and conveying the substrate by a substantially same distance as in Step (d) by unrolling the substrate by the first roll and taking up the substrate by the second roll; and
(l) after Step (k), opening the shutter member, forming the first deposited film in the first deposition possible region on a fourth film formation region which is located on the first surface and is not continuous with the third film formation region, and at the same time, forming the second deposited film in the second deposition possible region on the first deposited film formed on the third film formation region in Step (j), the second deposited film having a different growth direction from the first deposited film, further forming the third deposited film in the third deposition possible region on the second deposited film formed on the second film formation region in Step (j), the third deposited film having a different growth direction from the second deposited film, and further forming a fourth deposited film in the fourth deposition possible region on the third deposited film formed on the first film formation region in Step (j), the fourth deposited film having a different growth direction from the third deposited film.

9. The deposited film forming method according to claim 2, wherein in Step (a), the substrate is held such that: between the first roll and the second roll on the conveyance passage of the substrate, the surface exposed to the deposition material is inverted by an inversion mechanism provided on the second roll side of the second deposition possible region to cause a second surface that is a surface opposite to the first surface to face the evaporation source; and a third deposition possible region is formed, which is not continuous with the second deposition possible region and is located on the second roll side of the inversion mechanism on the conveyance passage of the substrate,
the method further comprising the step of:
(m) after a rear surface of the first film formation region reaches the third deposition possible region by the conveyance of the substrate in Step (d′), opening the shutter member and forming the first deposited film on the rear surface of the first film formation region in the third deposition possible region.

10. The deposited film forming method according to claim 9, wherein in Step (a), the substrate is held such that: between the first roll and the second roll on the conveyance passage of the substrate, the second surface is convex with respect to the evaporation source by a second guide member provided on the second roll side of the third deposition possible region in the deposition possible region; and a fourth deposition possible region is formed, which is not continuous with the third deposition possible region and is located on the second roll side of the second guide member on the conveyance passage of the substrate,
the method comprising the steps of:
(n) after Step (m), closing the shutter member to shield the substrate from the evaporated deposition material and conveying the substrate by a substantially same distance as in Step (d) by unrolling the substrate by the first roll and taking up the substrate by the second roll; and
(o) after Step (n), opening the shutter member, forming the first deposited film on the rear surface of the second film formation region in the third deposition possible region, and at the same time, forming the second deposited film in the fourth deposition possible region on the first deposited film formed on the rear surface of the first film formation region in Step (m), the second deposited film having a different growth direction from the first deposited film.

11. A battery polar plate comprising: a sheet-shaped substrate; and a deposited film including a plural-layer-structure active material body having four or more layers stacked on the substrate, wherein:
a growth direction of the active material body is inclined with respect to a normal direction of the substrate;
adjacent two layers in the plural-layer-structure active material body are different from each other in the growth direction of the active material body; and
a (3z+1)-th layer is twice as thick as each of a 3z-th layer and a (3z−1)-th layer (z is an integer of 1 or more).
